(19) United States
(12) Patent Application Publication
(10) Pub. No.: US 2008/0004850 A1
(43) Pub. Date: Jan. 3, 2008

(54) Method of Universal Formability Analysis in Sheet Metal Forming by Utilizing Finite Element Analysis and Circle Grid Analysis

(75) Inventor: YE WANG, Novi, MI (US)

Correspondence Address: KARL PENG, 24450 BETHANY WAY, NOVI, MI, 48375, US

(73) Assignee: PHIDA, INC., TAYLOR, MI (US)

(21) Appl. No.: 11/422,322

(22) Filed: Jun. 5, 2006

(51) Int. Cl. G06F 17/50

(52) U.S. Cl. 703/13

(57) ABSTRACT

The present invention provides a formability analysis method for sheet metal forming processes with the universal formability technology (UFT) by using finite element analysis (FEA) and circle grid analysis (CGA). This method comprises the processes of processing mechanics data of strains and displacements from a defective formed workpiece obtained from FEA and CGA, creating formability diagrams, calculating formability indexes, identifying formability status through comparing the formability indexes with the formability diagrams, and developing two formability solutions metal forming defects. One is the reliability ranges of the stamping process, which is described with the stamping process window including the formability, material and tooling windows; the other is the solution for stamping defects presented as the amounts of metal flow adjustments and the intervals of the associated stamping variables. The method conducts six types of formability analyses corresponding to the six types of stamping defect concerns: anti-fracturability versus split in stamping, anti-edge-fracturability versus split on stamping edge, anti-wrinklability versus wrinkle, shape-fixability versus shape change, stretchability versus low stretch, and anti-bucklability versus surface soft. This method is applied for the whole die life cycle including the forming die surface design, forming die construction, and stamping production.

### FIELD OF THE INVENTION

This present invention generally relates to formability analysis, using the mechanics data provided by finite element analysis (FEA) or circle grid analysis (CGA), to evaluate performance of forming processes for making stamped parts. More specifically, this invention provides a process for calculating the formability indexes, establishing formability diagrams, determining the formability status, establishing the formability reliability range of a stamping process, and developing solutions for stamping defects.

### BACKGROUND OF THE INVENTION

### PUBLICATIONS

[1] Keeler, S., “Plastic Instability and Fracture in Sheets Stretched Over Rigid Punches”, Sc.D. thesis, MIT, 1961.

[2] Goodwin, G. M., “Application of Strain Analysis to Sheet Metal Forming Problems in the Press Shop”, SAE paper, No 680092, 1968.

[3] Hill, R., “On Discontinuous Plastic States with Special Reference to Localized Necking in Thin Sheets”, J. Mech. Phys. Solids, V. 1, No 1, 1952.

[4] Martin, R., “Les Courbes Limits de Rupture et de Striction des Toles Minces”, Application, CETIM-Informations, No 32, 1973.

[5] Marciniak, Z., and Kuczynski, R., “Limit Strains in the Processes of Stretch Forming Sheet Metal”, Int. J. Mech. Sci., V. 9, 1967

[6] Xu, Y., Mordern Formability: Measurement and Applications, Hanser-Gardner Publications, Inc., Cincinnati, 2006.

[7] Yoshida, K., “A Quarter Century of Japanese Cooperative Activities in Sheet Metal Forming”, in Formability 2000 A.D., ASTM Symposium, Chicago, 1980.

[8] Xu, Y., Stamping Problem Diagnosis, Solving and Prevention, ASM International, Materials Park, to be published.

### NOMENCLATURE

English Characters

| | |
|---|---|
| DC | deformation capacity of sheet metal |
| DCₑ | deformation capacity near blank edge |
| grad(ε_{qcl1}) | major strain gradient along a quasi-contour line |
| grad(ε_{qcl2}) | minor strain gradient along a quasi-contour line |
| grad(θ_{qcl}) | major strain orientation gradient along a quasi-contour line |
| J₃′ | 3^{rd} invariant of deviatoric stress tensor |
| l | distance between two deformed circles, or distance between |
| | a deformed circle and the intersection point between a |
| | QCL and the line of the two deformed circle centers |
| n | strain(work)-hardening exponent |
| R | coefficient of normal anisotropy |
| r | die radius; inside stamping radius |
| RCMD | remaining capacity of material deformation |
| RCMDₑ | remaining capacity of material deformation near stamping |
| | edge |
| t | current thickness of sheet metal |
| tₒ | original thickness of sheet metal |
| u | current displacement along a QCL segment |
| u^{c} | displacement when a QCL segment has the critical |
| | instability with the compression strain (ε^{c}) |
| u^{t} | displacement when a QCL segment is stretched to the tension |
| | strain threshold (ε^{t}) |
| uₘₐₓ | the maximum displacement along a QCL segment with the |
| | constant strain εₘₐₓ |
| uₘᵢₙ | the minimum displacement along a QCL segment with the |
| | constant strain εₘᵢₙ |

Greek Characters

| | |
|---|---|
| Δh_{b} | burr height |
| Δhₛ | normal displacement of shape change |
| Δh_{w} | wrinkle height |
| Δl | linear increment |
| ΔRCMD | variable safety factor for criterion of split in stamping |
| ΔRCMDₑ | safety factor for criterion of split on stamping edge |
| ΔRCMDₒ | constant safety factor for criterion of split in stamping |
| δRCMD | refinement factor for ΔRCMD |
| ε^{c} | compressive strain at the critical instability on a QCL segment |
| εₑ | equivalent strain |
| εₑ^{l} | lower boundary of stretchability/anti-bucklability range |
| εₑ^{u} | upper boundary of stretchability/anti-bucklability range |
| εⱼ | current strain along a QCL segment |
| εₘₐₓ, εₘᵢₙ | the maximum, the minimum strain along a QCL segment |
| ε_{qcl1}, ε_{qcl2} | major, minor strain on a quasi-contour line |
| ε^{t} | tension strain threshold on a QCL segment |
| εₜ | thickness strain of sheet metal |
| ε₁ | major strain in formability; 1^{st} principal strain in plasticity |
| ε₂ | minor strain in formability; 2^{nd} principal strain in plasticity |
| ε₃ | 3^{rd} principal strain in plasticity |
| θ_{qcl} | included angle between the major strain and the tangent line |
| | of quasi-contour line |
| σₜ | principal stress in thickness direction |
| σ₁, σ₂, σ₃ | 1^{st}, 2^{nd}, 3^{rd} principal stress |

### ACRONYM AND GLOSSARY OF TERMS

Bending Process Model—A deformation pattern for describing characteristics of stress and strain distributions and loading sequence in a (2D) stamping radius during bending process.

CGA—Circle Grid Analysis. An experimental analysis method to evaluate the performance of a forming process in regard to formability requirements by measuring strains and/or displacements on deformed circles of a formed workpiece.

Consistent Deformation—In a forming process, if deformation in an area of sheet metal can be described by only one forming mode, the deformation in the area is consistent.

Critical Point—Unique combination between stress and strain components in stress and strain spaces.

Deformation Capacity of Sheet Metal—Deformation at the necking points in different strain states on FLC.

Deformation Capacity Near Blank Edge—Deformation near a cut edge of sheet metal at the necking point in the simple tension state. The cut edge condition of sheet metal is quantified by the ratio of burr height to sheet metal thickness.

Deformation History—Strain accumulation versus a forming process, including consistent and non-consistent deformation.

Deformation Pattern—Deformation characteristics (properties) in sheet metal during forming, including forming mode and bending process model.

Deformation Region—A defined area in a formed workpiece, where formability analysis is conducted.

Deformation Zone—An area in a deformation region of a formed workpiece, where strains vary within a certain range quantified by the maximum strain measurement error.

Die Gap—A clearance between sheet metal and die surface when the forming die is closed.

FEA—Finite Element Analysis. A numerical simulation method to predict the performance of a forming process in regard to formability requirements, given sufficient definitions of die component geometries and their kinematics, as well as mechanics properties of sheet metal.

Formability Diagram—A deformation limit diagram including the safe, marginal and failure zones, which are defined by the formability range, safety factor and stamping defect criterion respectively. There are six types of formability diagrams regarding the six types of stamping defect concerns.

Formability Index—A parameter generated through processing mechanics data (strains or displacements) and used to conduct formability analyses and present formability solutions.

Formability Range—Formability variation within safe status. There are six types of formability ranges versus the six types of stamping defect concerns. Each formability range is defined by the upper and lower boundaries.

Formability Window—The overlapped interval of operational formability ranges with regard to all existing stamping defect concerns with safe status in a stamping process.

Formed Workpiece—A workpiece just comes out of the forming operation.

Forming Die—A die used to form the major shape of stamped part.

FLC—Forming Limit Curve. A curve along which local necking occurs in sheet metal with different combinations between major and minor strains in plane stress states.

Forming Mode—A deformation pattern for describing characteristics of combinations between stress and strain states in a stamping area in plane stress states in a forming process. There are six forming modes in the stress and strain spaces.

Global Metal Flow—A metal flow in a deformation region/zone, during which the ratio of deformation to forming process is equal to or greater than 1.

Linear Straining Path—A deformation process with the constant ratio between three principal strains at a point of sheet metal.

Local Metal Flow—A metal flow in a deformation region/zone, during which the ratio of deformation to forming process is less than 1.

Low Stretch—Deformation in a large, flat/sweep area of a formed workpiece is lower than the requirement.

Mechanics Data—Any data describing mechanical responses in a forming process, including strains and displacements in elements or deformed circles, as well as other data obtained by using FEA or CGA.

Major Strain—Algebraically larger principal strain in a planar direction of a formed workpiece. It can be either the 1^{st} or 2^{nd} principal strain in plasticity.

Material Window—The maximum accepted interval of material properties in a stamping process to make qualified stampings.

Metal Flow Pattern—Deformation accumulation versus a forming process, including global and local metal flow.

Minor Strain—Algebraically smaller principal strain in a planar direction of a formed workpiece. It can be either the 2^{nd} or 3^{rd} principal strain in plasticity.

Non-Consistent Deformation—In a forming process, if deformation in an area of sheet metal is described by two or more forming modes, the deformation in the area is non-consistent.

Operational Formability Range—Reachable formability interval defined by the difference between the current formability index and the boundary near the stamping defect criterion.

Original Deformation Field—A random vector field obtained by using FEA or CGA, including strain, stress, displacement field, etc.

Principal Strain—Strain on a plane where there is no shear strain, including 1^{st}, 2^{nd} and 3^{rd} principal strain.

Product Specification—Customer requirement of product function and quality.

QCL—Quasi-Contour Line. A reference line along which strain gradients are calculated as formability indexes.

Remaining Capacity of Material Deformation—The deference between the deformation on FLC and the maximum deformation in a deformation zone of a formed workpiece in the linear straining direction.

Safety Factor—A value of formability index, which is greater than the sum of half of measurement variation of stamping defect and half of formability measurement variation. It defines a marginal zone in formability diagram to keep the safe and unsafe formability status to be clearly identified.

Shape Change—The shape of a formed workpiece or stamped part is out of the shape specification.

Split in Stamping—A rupture, which occurs inside of a formed workpiece.

Split on Stamping Edge—A rupture that occurs along stamping edge.

Stamped Part—A sheet metal part that just comes out of the last operation in a stamping process.

Stamping Area—An area in a formed workpiece, whose relative curvature radii are equal to or greater larger than 25 and where there exist plane stress states.

Stamping Defect—A deformation magnitude/pattern of a stamped part is out of product specification. There are six types of stamping defects.

Stamping Defect Concern—A formability status in a deformation region/zone, whose deformation reaches such magnitude/pattern that its formability analysis is needed. The formability status of a stamping defect concern is either safe or unsafe.

Stamping Defect Criterion—A threshold of formability index for identifying the existence of a stamping defect.

Stamping Process—A serial operations through which a blank goes sequentially until a stamped part is obtained in the last operation.

Stamping Process Window—A reliability range of a stamping process to make qualified stampings and to keep the process under control. It includes the formability, material and tooling windows.

Stamping Radius—A tunnel shape element of a formed workpiece, in which its curvature radius is less than 25 times of sheet metal thickness.

Surface Soft—A large, flat/sweep area of a stamped part is not strong enough to bear a certain oil canning load due to the lower work-hardening and 1^{st} type of existing compressive residual stress that accelerates the elastic instability.

Structured Strain Field—A man-made vector field described with strains along specified reference lines.

Stamping Variable—A variable that affects the formability. All stamping variables are classified into seven groups: (a) part geometry, (b) material property, (c) die surface, (d) forming process, (e) blank geometry, (f) material handling, and (g) miscellaneous.

Tooling Window—The reliability interval of tooling facilities for making qualified stampings in a stamping process. It is described by the six types of stamping variables excluding the material property.

UFT—Universal Formability Technology. A tool package for formability analysis, including quantitative analysis tools (universal formability theory, stamping process window), qualitative analysis tools (forming mode theory, bending process model, control principles of metal flow tendency), and a data mining and method selection tool (stamping similarity theory).

Wrinkle A surface waviness due to plastic compressive instability in a formed workpiece.

Sheet metal forming is used in the manufacturing of a wide variarity of sheet metal parts. In the sheet metal forming process, a sheet metal blank is placed in a forming die to form a desired part. The forming dies are important tools of the sheet metal forming process. There are three stages in metal forming die life cycles:
1. Forming die surface design stage: the forming die surfaces are designed by CAD software based on the shape of a sheet metal part. Then, performance of the design of the die is verified using simulation software such as Finite Element Analysis (FEA).
2. Forming die construction stage: after the die design stage, the forming die is constructed and then tryouts are performed in a tool room or shop until an acceptable part is made and verified by using a physical measurement method such as Circle Grid Analysis (CGA).
3. Stamping production stage: following the die construction stage, the forming die is finely adjusted in a production line and validated by using CGA for the production preparation. It is then put in production to produce the formed parts within predetermined quality standards.

In the forming die surface design, the formability analysis is conducted to predict potential stamping defects. These defects must be solved and the die design performance is verified using FEA simulation. According to the parts to be formed by the forming die, a forming die surface is developed to meet the forming requirements. The finite element analysis programs, available from a varity of companies, can be used to predict the sheet metal flow and the deformation field in the forming die cavity. Based on the data in the deformation field, potential stamping defects can be diagnosed and solved by changing the stamping variables. This is an interactive process which is complete until the die surface design is verified. However, FEA analysis can only simulate forming processes with limited stamping variables. The complex metal flow cannot be fully predicted by using FEA. As a result, the verified forming die surface still have some potential stamping defects to occur in the die construction.

In the die construction, formability analyses are conducted to diagnose and solve the stamping defects according to the deformation fields measured by CGA. Generally, the forming dies constructed based on above verified die surfaces cannot make production parts because FEA model cannot duplicate the actual sheet metal forming process and because the new stamping variables are added in the die construction. As a result, the stamping defects occur during the die tryouts. In order to solve the stamping defects, the deformation field of a formed part is measured by using CGA method. Then, the formability analysis, based on the obtained strain information, is conducted again to diagnose the stamping defects, solve these defects, and check the forming die performance until quality parts are made.

In the preparation of the stamping production, the formability analysis is conducted to solve stamping defects based on the deformation fields measured by CGA method. Although the forming die has been verified in the tool room or shop, still, it may not make qualified parts in a production line because of the constant changes of many stamping variables and the additions of new stamping variables. In such situation, formability analysis has to be conducted again using CGA method to diagnose and solve the stamping defects until good quality parts are made in the production line.

In the final stamping production, the reliability of a stamping process is measured and maintained by conducting formability analysis based on the deformation fields measured using CGA method. The reliability of a stamping process is described as stamping process window that includes the formability window, the material window, and the tooling window. After all of the stamping defects are fixed, the forming die is used in the normal production. In the normal production, the formability analysis is constantly conducted again using CGA method to measure, and control the stamping process window to assure that the formed produciton parts are in predetermined quality.

In the formability analyses described above, FEA or CGA is used individually and separately as a tool to conduct the formability analysis for the die life cycle including the forming die design and construction, and production of the sheet metal forming. FEA and CGA perform two functions: data provider to obtain mechnics information in terms of strain, stress, displacement fields, and analysis excutor to conduct formability analysis. The formability analysis, based on FEA and CGA tools, is applied to improve the quality of formed sheet metal parts and to maintain/enhance the reliability of stamping process, to short the forming die delivery time and reduce the breakdown time during the stamping production, and to reduce cost of the die construction and stamping production.

Normally, the formability analysis based on FEA or CGA includes the prelimilary data processing, the identification of formability status, the maitennace or enhancement of the reliability of stamping process when the formability status is safe, and the determination of the metal flow adjustments when the formability status is unsafe. Currently, FEA and CGA, employing the 1960's formability theories, use mechanics data to measure partial stamping defect concerns. FEA and CGA have limited capabilities to implement formability analysis. The non-indexed mechanics data can not apply to modern formability theories and deformation field analysis. Some stamping defect concerns, such as micro-level wrinkls and oil canning, cannot be measured due to the shortage of corresponding formability parameters. As a result, the formability status cannot be fully determined, especially for the concerns of surface and shape defects. Even though FEA and CGA can identify some stamping defects, neither can determine the optimal metal flow adjustments without sufficient information. Moreover, FEA and CGA cannot be applied to the high-level formability analysis because the mechnics data cannot be fully intepreted due to limitations of early formability theories. As a result, engineers have to do formability analysis manually using their own skills and experiences to compensate the shortcomes of FEA and CGA, and solve stamping defects through the trial-and-error process, which is time consuming and costly.

Following is the descriptions of some basic concepts of stamping defects, formability analysis process, and development history of formability theories.

Based on deformation mechanisms of stamping defects, all of the stamping defects are classified into six categories as follows:
1. Split in stamping. When the plastic deformation reaches a certain magnitude in a sheet metal blank in the forming process, the deforming process will concentrate in the location with a mechanical damage until split occurs.
2. Split on stamping edge. When a sheet metal blank edge is stretched to a certain magnitude, the combination of existing burrs, micro-cracks and work-hardened zone on/near the blank edge acts as a fracture factor to make the deformation process concentrate an area near the blank edge, causing ruptures.
3. Wrinkle. When a deformation region in a blank suffers compression strains and stresses in a forming process, in conjunction with its geometry, plastic instability occurs, causing waviness on stamping surfaces. Based on wrinkle height, all wrinkles are classified as Type-I, -II and -III wrinkle.
4. Shape change. After unloading, the elastic recovery occurs in a formed workpiece, causing the corresponding stamped part' shape out of its specifications.
5. Low stretch. When the insufficient deformation occurs in a formed workpiece, the corresponding stamped part is not work-hardened enough, causing low dent resistance and strength.
6. Surface soft. When compressive residual stresses exist in a formed workpiece after it is partially unloaded, the residual stresses accelerate the elastic instability in the corresponding stamped part, causing reduction of oil canning load.

In the forming die life cycle, the formability analyses are conducted to solve above stamping defects. The methods used to perform the formability analysis are:
1. Numerical Calculation. FEA software is used to simulate a forming process. The advantage of the numerical calculation is that the formability status of a forming process can be predicted and some potential stamping defects can be solved during the forming die surface design before it is constructed.
2. Physical Measurements. Using CGA method, grids with a certain geometric pattern, either a circular or other shapes, are marked on a sheet metal blank. After the sheet metal blank is formed in the die, the strains and displacements on the deformed grids on the formed workpiece are measured. Then, formability analysis for the forming process is conducted. CGA can obtain real deformation fields of a formed workpiece. Therefore, it can only be used during the forming die construction and stamping production stages, but not in the forming die design stage.

So far, five significant milestones of formability theory development have been achieved since the 1950s as follows.
1. The first milestone is the work in the 1950s by Landford, Snyder and Bauscher for discovering n-value, and the work by Philips and Dunkle for discovering R-value when the development of formability theory started. n- and R-values are taken as two basic parameters used to characterize sheet metal properties for forming process. Both have been taken into account in the theory of sheet metal forming plasticity and formability analysis.
2. In the 1960s, establishing a splitting criterion was the major concern when sheet metals were widely applied in automotive and aircraft industries. In order to meet the industrial demand, Keeler and Goodwin conducted experimental research of splitting criterion. Keeler established the splitting criterion in bi-tension deformation states [1]; and Goodwin in the tension-compression deformation states [2]. Putting both together, a splitting criterion, which presents the local necking curve in different plane stress states and is referred as forming limit curve (FLC), was established. Making a translation of the local necking curve in the minor strain direction by a safety factor, the safety margin is generated. The combination of the local necking curve and the safety margin is referred to as the forming limit diagram (FLD). This is considered as the second milestone. FLD has been widely applied for formability analysis in stamping industry. The deformation severity at a point is not indexed because it is directly shown in the FLD by mechanics data (major and minor strain). The straining path is also not shown up. Therefore, FLD cannot determine the amount of metal flow adjustment for eliminating a split in stamping when it occurs.
3. In parallel to the experimental research, as the third milestone, mechanics analyses regarding local necking of sheet metal were approached for establishing theoretical curves of local necking by many researchers from the 1950s to 1970s [3-5]. These study results, on small or large scale, present local necking characteristics and trends, and are shown in the theory of sheet metal forming plasticity. No one, however, can be applied for formability analysis because these results cannot precisely describe the local necking of sheet metals. In fact, as summarized in reference [6], all defect criteria in sheet metal forming must be established through experiments.
4. The fourth milestone is the work completed by Yoshida [7] on overall formability. Formability development started to focus on surface and shape defects and quality concerns in the 1980s. Yoshida developed the overall formability, including anti-fracturability, shape-fixability, and die-fitability. Anti-fracturability is the traditional formability presented with FLD; shape-fixability describes shape changes (springback and distortion); and die-fitability identifies the relationship between forming die surface and formed workpiece geometry. In his study, both the shape-fixability and die-fittability are case- and geometry-based measurements. Their measurement parameters cannot be processed into rational ones for general applications. Therefore, the overall formability cannot be implemented in FEA simulation.
5. Since the 1990s, intension of formability theory development has been focusing on how to fully diagnose, solve and prevent sheet metal fracture, surface defects, shape changes and usage performance defects. Quality requirements of sheet metal products have become much stricter. The huge amount of mechanics data in terms of deformation fields needs to be processed during formability analysis by using FEA and CGA. The modern stamping industry needs more robust methods of formability analysis for the forming die making and stamping production. In order to provide a more reliable technology with a more accurate and full description of the ease or difficulty of making qualified stamped parts and products, especially regarding to surface quality, shape accuracy and usage performance, the universal formability technology (UFT) has been developed [8]. As a package of formability analysis technologies, it includes the following contents.
   A. Forming mode theory. Formed workpiece include stamping areas and radii. Sheet metal forming in stamping areas belongs to the plane stress state. Stresses and strains in the plane stress state have combined-characteristics. All of the combined-characteristics are categorized as six zones that are sequentially located in both the stress and strain space. Each zone presents a unique forming pattern, referred as a forming mode. Every stamping area in a formed workpiece can be characterized by one or more forming modes.
   B. Bending process models. Sheet metal is formed into stamping radii with the action of both bending moment and tension force. Elastic, elastic-plastic, and plastic deformation occur sequentially. When sheet metal starts the plastic deformation, the action of bending moment and tension force becomes an irreversible loading process. Different loading sequences result in different forming patterns in stamping radii. Deformation states in stamping radii are related to both the loading sequence and magnitudes of their relative radii. Combining (a) stress state, (b) relative radius, and (c) loading sequence together, all forming patterns of sheet metal around die radii, which are referred as bending process model, are generated and characterized regarding to the existence of the thinning and lock angle. The bending process models can describe all deformation characteristics in stamping radii. They also establish coupling relationships between metal flows and die radii, especially for complex, automotive body panels.
   C. Universal formability theory. Each type of stamping defect concerns has its own mechanics characteristics. Theoretically, these mechanics characteristics can be quantified and indexed with (a) extreme strain, (b) strain gradient, and (c) displacement. Mechanics data, such as strain, displacement, etc., which are obtained in FEA simulations and CGA, can be processed into formability indexes to describe the ease or difficulty of making qualified parts. In parallel to the six types of stamping defects, six types of formability analyses are defined with formability indexes:
      i. anti-fracturability index (RCMD) versus split in stamping,
      ii. anti-edge-fracturability index (RCMDₑ) versus split on stamping edge,
      iii. anti-wrinklability index [Δh_{w}, grad(ε_{qcl1}), grad(ε_{qcl2}), grad(θ_{qcl})] versus wrinkle,
      iv. shape-fixability index [Δhₛ, grad(ε_{qcl1}), grad(ε_{qcl2}), grad(θ_{qcl})] versus shape change,
      v. stretchability index (εₑ) versus low stretch, and
      vi. anti-bucklability index [εₑ, grad(ε_{qcl1}), grad(ε_{qcl2})] versus surface soft.
   These formability indexes are used to present (a) formability measurement, (b) stamping defect criterion, (c) amount of metal flow adjustment, and (d) formability window. The universal formability theory can describe all six types of stamping defect concerns.
   D. Stamping process window. When a stamping defect occurs, the corresponding formability index reaches an extreme value. The extreme value is the threshold of the formability index for identifying the existence of the stamping defect. The threshold of the formability index is referred to as a “defect criterion”. In reality, the defect criterion varies in a narrow range due to variations of affecting factors, so does the measurement of the corresponding formability index. A marginal zone, which is greater than the sum of half of the two variations, is defined as the safety factor. Underneath the safety factor, the formability status is safe, and formability index can vary in a reliable range where qualified (defect-free) stampings can be made during the normal production. The reliable range of formability is defined as the “formability window”, which is also described by the formability index. The corresponding domain of stamping variables is defined as the “material window” and the “tooling window”. The former presents the variation ranges of material properties for forming requirements; the latter to the variation ranges of all the other stamping variables. Both the material and tooling windows are quantified with critical stamping variables that are identified through formability analysis. Finally, putting the formability, material, and tooling windows together, the reliability range of the stamping process is established. This reliability range is referred to as the stamping process window (SPW) for production stability evaluation and control.
   E. Control principals of metal flow tendency. Sheet metal flow means that a blank is forced to change its shape into the target shape, which is bound with the upper and lower forming die surfaces. The essence/rationale of metal flow control, therefore, is (a) to maximize the rigid movement, (b) to keep the plastic deformation even as much as possible, and (c) to constrain the plastic deformation within a certain range. Two types of guidelines, referred to as control principles of metal flow tendency (CPMFTs) have been developed. One group includes fundamental principles for metal flow control without or with a limited consideration of die surface. The other group includes application principles for metal flow control regarding global die surface variables. Both types of CPMFTs are used for metal flow analysis and problem solving.
   F. Stamping similarity theory. Beyond FEA and CGA, there are so many other formability analysis tools that can be used to do formability analyses and then to deliver a certain level results versus a real sheet metal forming process. The stamping similarity theory has been developed to evaluate their capabilities to present results versus the reality. The theory shows that the similarity degree of every analysis method (formability analysis tool) versus a real forming process needs to be evaluated with the fidelity of both stamping variables and mechanics parameters. The mechanics parameters mainly include (a) formability indexes, (b) forming modes, and (c) bending process models. When a similarity level is determined for a formability analysis, using the stamping similarity theory, a formability analysis tool can be selected for the formability analysis. The theory is also used for the validation of stamping data and formability expert system development.
As the 5^{th} milestone of formability theory development, UFT has been applied to the die engineering and stamping production by using both FEA and CGA. Success stores include (a) diagnosis, solving and prevention of all types of stamping defects, (b) guidance of sheet metal part and forming die surface design, (c) selection of sheet metal, and (d) establishment of reliability range of a stamping process. Fundamentals, application procedures, and major application achievements of UFT have been summarized as a book [6]. The decent applications will be published as another book [8] soon. In these applications, all calculations, such as formability indexes, formability windows, amounts of metal flow adjustments, etc., are manually completed, not automatically conducted by using a computer.

In summary, FEA and CGA can provide huge mechanics data in terms of deformation fields by applying 1990's numerical calculation and measurement technologies. Formability analyses by using FEA and CGA, however, are not fully automated because they only implement 1960's formability theories. Currently, FEA and CGA can conduct a part of formability analyses, not all of the six types of formability analyses. In order to enhance and develop capacities of formability analyses by using FEA and CGA, it would, therefore, be desirable to provide an agrithm and a method to implement the morden formability theory—universal formability technology (UFT)—for all of the six types of formability analyses. This method makes FEA and CGA (a) calculate formability indexes, (b) identify the formability status, (c) establish the stamping process window, and (d) determine the amount of metal flow adjustment for solving stamping defects.

Today's stamping industry requires more nimble, robust and stable process to make good quality products. Product quality standards become higher and the stamped parts become more complex; the forming processes are more and more complicated. In addition, as new sheet metals are continuously developed for the stamping industry, more sophisticated formability technologies, therefore, must be integrated into FEA and CGA to conduct advanced formability analysis to satisfy these stamping requirements. The primary objective of this present invention is to develop such formability analysis process to meet these requirements.

### SUMMARY OF THE INVENTION

It is that, therefore, an objective of the present invention, using FEA and CGA, is to provide a method for processing mechanics data, provided by FEA and CGA methods, into formability indexes for conducting formability analysis. The present invention overcomes the drawbacks of the existing formability analysis.

The present invention applies the universal formability technology, the universal formability theory, stamping process window, forming mode theory, and bending process models, into six types of standard formability analyses: anti-fracturability, anti-edge-fracturability, anti-wrinklability, shape-fixability, stretchability and anti-bucklability, corresponding to the six types of stamping defects: split in stamping, split on stamping edge, wrinkle, shape change, low stretch and surface soft.

Another objective of the present invention is to identify the formability status for all the six types of stamping defect concerns in each deformation region/zone of a formed workpiece by comparing formability indexes to the corresponding stamping defect criteria to determine whether the formed workpiece is safe.

Yet another objective of the present invention is to provide the formability solutions after the formability status is identified. If the formability status is unsafe, that is to say, one or more stamping defects exist, amounts of metal flow adjustments quantified with strains and/or displacements are determined for solving the stamping defects. The metal flow adjustments would be further transformed into a domain of critical stamping variable adjustments. This analysis process significantly reduces the time of the problem solving and change the troubleshooting procedure from the trail and error to more accurate quantitative and semi-quantitative computations. If the formability status is safe, that means no stamping defect, the reliability range (stamping process window) of the stamping process is established for the stability control of stamping process. This invention significantly reduces the cost and time to develop stamping tooling, increase stamping productivity, and improve stamping quality.

The present invention also provides a method to conduct the formability analysis using FEA and CGA. This method can be embedded into the preprocessor and the postprocessor of FEA software, or written as stand-alone software to be integrated into the current FEA codes. For the formability analyses by using CGA, the method can be partially embedded into the software of circle grid analyzers, or written as a stand-alone software for formability analyses.

### BRIEF DESCRIPTION OF THE DRAWINGS

Novel features of the invention are described in the appended claims. The invention itself, including objectives, advantages, will best be understood by reference to the following detailed description of illustrative embodiments in conjunction with the accompanying drawings, wherein:

FIG. 1 is the block diagram of the overall process of formability analysis with UFT using FEA and CGA.

FIG. 2 is the forming mode distribution diagram in the strain and stress spaces.

FIG. 3 is the stress and strain distribution diagram of the six forming modes.

FIG. 4 is the stress and strain combinations of forming modes and critical points.

FIG. 5 is ranges of the ratio of the minor to the major strain of the six forming modes.

FIG. 6 is relations between the bending process models and the associated deformation characteristics in different relative radii.

FIG. 7 is the metal flow pattern diagram.

FIG. 8 is the block diagram of anti-fracturability analyses for concerns of split in stamping in the formed workpiece.

FIG. 9 is the anti-fracturability diagram for identifying anti-fracturability status in each deformation zone, determining a part of stamping process window, and developing solutions for splits in stamping.

FIG. 10 is the block diagram of anti-edge-fracturability analyses for concerns of split on stamping edge of a formed workpiece.

FIG. 11 is the anti-edge-fracturability diagram for identifying anti-edge-fracturability status in each deformation zone, determining a part of stamping process window, and developing solutions for splits on stamping edge.

FIG. 12 is the block diagram of anti-wrinklability analyses for wrinkles in the formed workpiece.

FIG. 13 is the anti-wrinklability diagram for identifying anti-wrinklability status in each deformation region, determining a part of stamping process window, and developing solutions for wrinkles.

FIG. 14 is the block diagram of shape-fixability analyses for shape change concerns in the formed workpiece by using FEA and CGA.

FIG. 15 is the shape-fixability diagram for identifying shape-fixability status in each deformation region, determining a part of stamping process window, and developing solutions for shape changes.

FIG. 16 is the block diagram of stretchability analyses for low stretch concerns in the formed workpiece using FEA and CGA.

FIG. 17 is the stretchability/anti-bucklability diagram for identifying stretchability/anti-bucklability status in each deformation zone, determining a part of stamping process window, and developing solutions for low stretches or surface soft.

FIG. 18 is the block diagram of anti-bucklability analyses for surface soft in the formed workpiece using FEA and CGA.

### DETAILED DESCRIPTION OF THE PREFERRED EMBODIMENTS

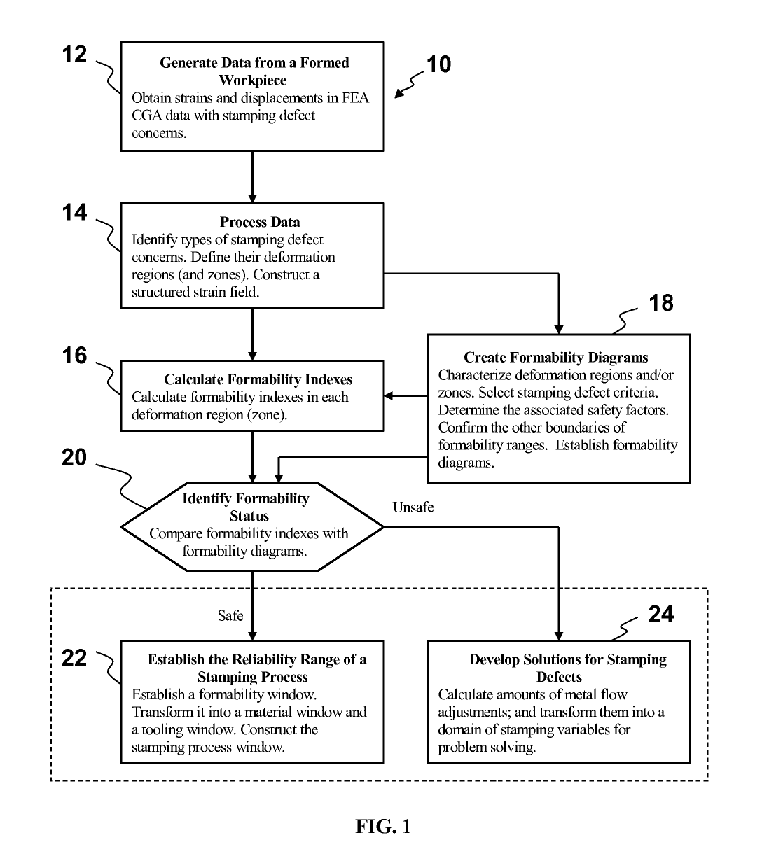

With reference now to the figures depicted the method of formability analysis using FEA and CGA. As explained below, FIG. 1 describes the overall process of formability analysis with UFT. Procedures of each type of the formability analysis are depicted with the following figures. Capacities of formability analysis by using FEA and CGA may be created, updated and enhanced in accordance with the present invention, see detailed descriptions below.

Universal Formability Analysis—Overall Procedure

Referencing FIG. 1, an overall method 10 of formability analysis with UFT by using FEA and CGA is shown. In the beginning, mechanics data are obtained in block 12. The mechanics data comprises strains and displacements in a formed workpiece. The formed workpiece is either an FEA simulation output or a real workpiece. The stamping defect concerns exist in the formed workpiece. The formability status of the stamping defect concerns is either safe or unsafe. In FEA, the mechanics data can be collected on each element of the formed workpiece in the postprocessor; in CGA, they can be collected on each deformed circles of the formed workpiece. The obtained mechanics data are the resources for formability analysis and sent to block 14.

In block 14, deformation regions (and zones) are defined and then the original deformation field in the formed workpiece is structured by using the data from block 12. Stamping defect concerns generally do not occur everywhere in the formed workpiece. Formability analysis is only conducted in places where the stamping defect concerns exist in the formed workpiece. Deformation regions, where there exist the stamping defect concerns, therefore, need to be defined for conducting formability analysis. Each stamping defect concern has its own deformation region. Based on the magnitude level of strains and displacements from block 12, stamping defect concerns and the associated deformation regions are determined. If needed, deformation zones in a deformation region are further defined based on the range of strain measurement errors. Stamping defect concerns and the associated deformation regions can also be predetermined based on the product quality requirements. In such situation, the predetermined stamping defect concerns and deformation regions are directly identified in block 14. The original deformation field in the formed workpiece, which is obtained from FEA or CGA in block 12, is a random vector field. In order to conduct analyses of anti-wrinklability, shape-fixability, stretchability and anti-bucklability in deformation regions of the formed workpiece, the random vector field must be structured for strain gradient calculations. Quasi-contour lines (QCLs) on each deformation region of the formed workpiece are either predetermined or generated as reference lines for the strain gradient calculation. In FEA, QCLs can be put first in FEA model in the preprocessor, and then mapped onto the formed workpiece in the postprocessor after FEA simulation is completed. In the condition that wrinkle concerns with strains larger than 10%, QCLs are directly generated on the formed workpiece. Strains along the QCLs are directly obtained from elements that meet the QCLs. In CGA, QCLs are directly marked on the formed workpiece. Then, strains on deformed circles that meet or are close to the QCLs are interpolated onto the QCLs. Finally, the deformation regions with the associated mechanics data, where there exist deformation zones and/or the structured strain field, are sent to both block 16 and block 18 respectively.

In block 18, the deformation regions (and zones) are characterized and then the formability diagrams for each stamping defect concern are established by using the data from block 14. In each deformation region/zone, by using the mechanics data obtained from block 14, conduct qualitative analyses including (a) forming mode area, (b) bending process model, (c) deformation history, (d) metal flow pattern, and (e) special properties if needed.

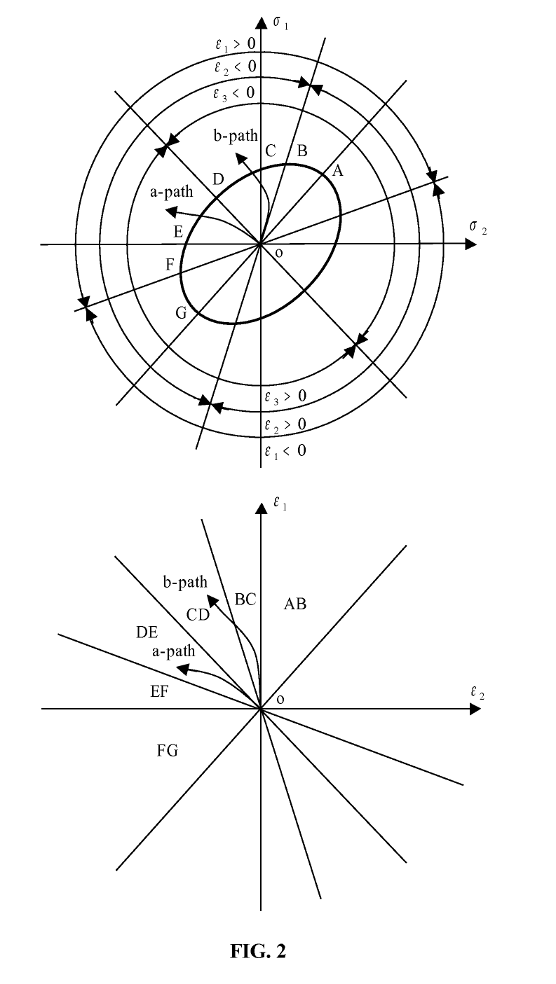

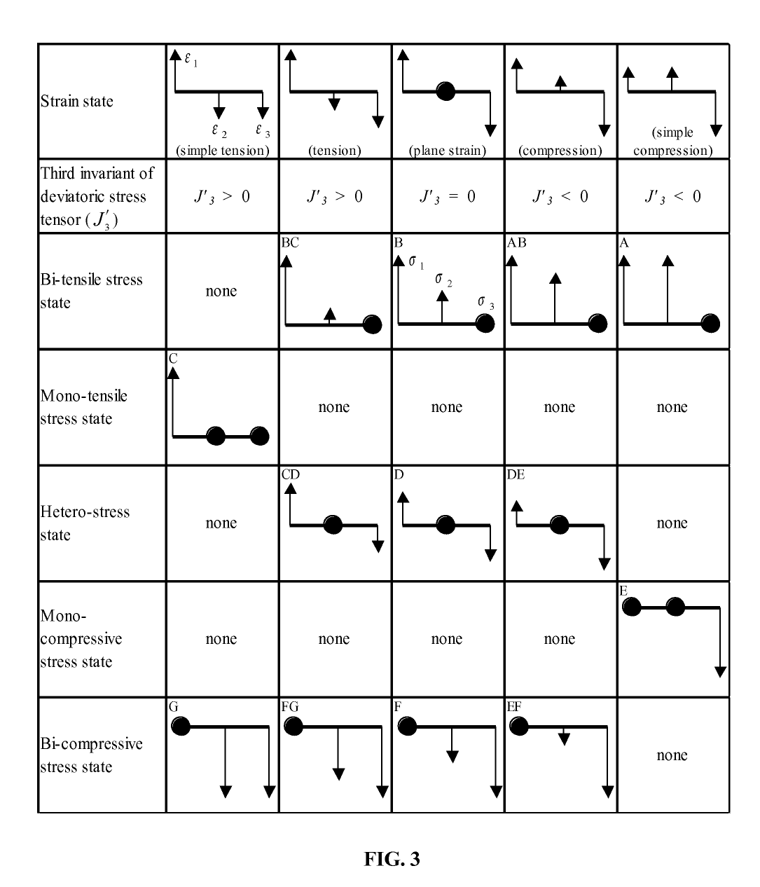

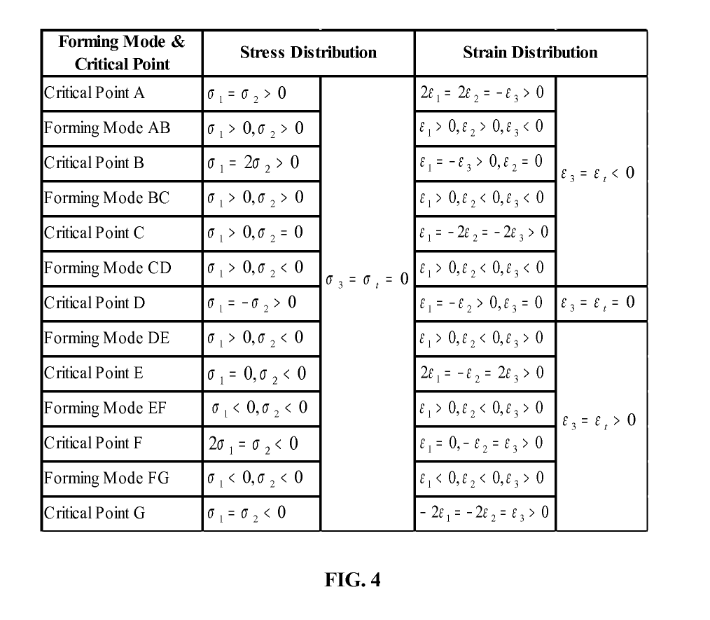

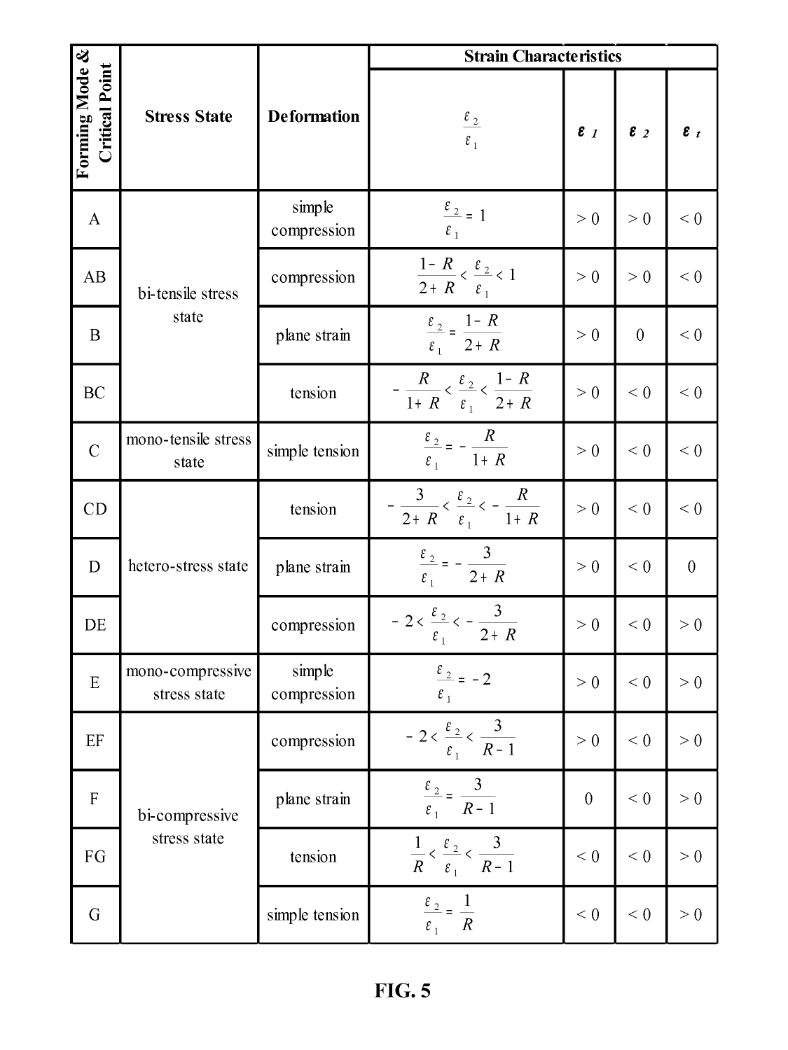

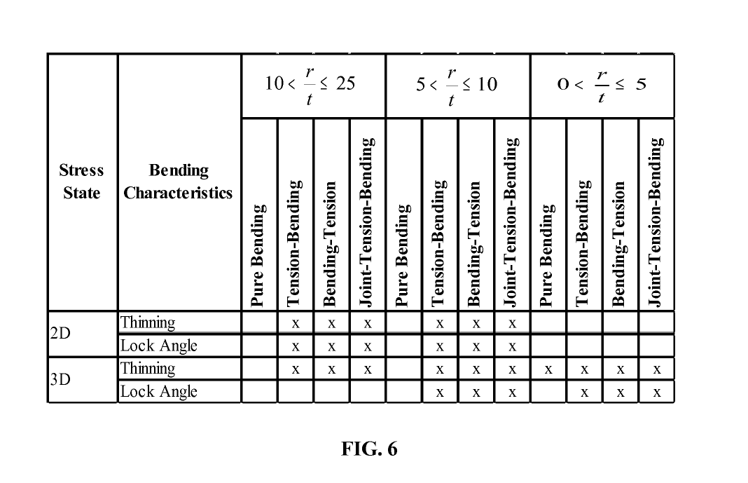

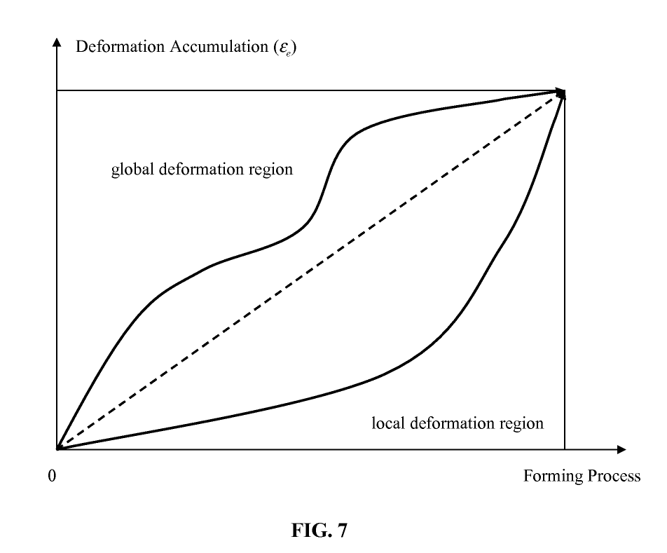

Referencing FIG. 2, a forming mode is defined as a deformation pattern with a unique stress and strain combination in the plane stress state at a point of sheet metal in a forming process. There are six forming modes bound with seven critical points: forming modes of AB, BC, CD, DE, EF and FG, and critical points of A, B, C, D, E, F and G, as shown in FIG. 3. Their stress and strain combinations are illustrated in FIG. 4. Each forming mode has a specific range of the ratio of the minor to major strain, as shown in FIG. 5. When elements/deformed circles with a same range of the ratio of the minor to major strain are adjacent each other, they are constructed into a forming mode area. The forming mode in the forming mode area is identified based on the ratio magnitude. A bending process model is a deformation pattern of sheet metal around a die radius in a forming process. Each bending process model has a specific deformation sequence, resulting in specific characteristics of stress and strain distributions in sheet metal in the forming process, as shown in FIG. 6. When the deformation sequence in sheet metal around a die radius is identified, the bending process model is determined, and the associated mechanics characteristics in sheet metal are found. The deformation history includes: (a) a consistent deformation described by only one forming mode shown as a-path in FIG. 2, and (b) a non-consistent deformation described by two or more forming modes shown as b-path in FIG. 2. Tracking forming mode changes at a point of sheet metal can identify the deformation history. In applications, using the ratio of the minor to major strain of the element/deformed circle with the maximum deformation, the forming mode change is identified, which presents the deformation history in the forming mode area. The metal flow pattern includes: (a) a global metal flow, in which the deformation accumulation in a deformation region/zone is equal to or ahead the forming process level, and (b) a local metal flow, in which the deformation accumulation is behind the forming process level as shown in FIG. 7. After a point with the maximum deformation in a deformation region/zone is identified, comparing the deformation accumulation of the point with the forming process level, the metal flow pattern can be determined. In applications, the metal flow pattern in a deformation region/zone is determined by tracking the deformation accumulation of the element/deformed circle with the maximum deformation. The obtained mechanics properties in all of the deformation regions and zones are applied for establishing formability diagrams and solving stamping defects.

Since there are different deformation characteristics and quality requirements in each deformation region/zone of a formed workpiece, formability diagrams for each stamping defect concern in each deformation region/zone needs to be established individually. There are six types of formability diagrams in regard to the corresponding six types of stamping defects. These formability diagrams are used to (a) calculate formability indexes, (b) determine formability status for each stamping defect concern, (c) establish the formability range of each stamping defect concern with safe status, and (d) calculate the amount of metal flow adjustment if the stamping defect concern is identified as unsafe status. Each formability diagram includes three zones: safe, marginal and failure zone. The three zones in each formability diagram are divided by the stamping defect criterion/criteria, safety factor(s) and boundary/boundaries of formability range. There are three databases of stamping defect criteria, safety factors and boundaries of formability ranges in block 18. Criteria of split in stamping, split on stamping edge, low stretch and surface soft are selected based on material grade and thickness of sheet metal; criteria of wrinkle and shape change are selected based on product specification in each deformation region of formed workpiece. As for the six types of the safety factors, the safety factors in regard to splits in stamping in each deformation zone are determined as a constant plus a refinement factor that is related to the characteristics of the deformation zone; the safety factor in regard to splits on stamping edge in the whole formed workpiece is determined as a constant; the safety factors in regard to wrinkles in each deformation region are determined based on the measurement errors of normal displacements; the safety factors in regard to shape changes in each deformation region are determined based on the differences between product specification and process control limits; the safety factors in regard to low stretches and surface soft are determined based on the strain measurement errors. Then, the selected stamping defect criteria and safety factors for each stamping defect concern in each deformation region/zone are refined and/or verified by using the characteristics of the deformation region/zone. A stamping defect criterion plus/minus the associated safety factor constructs one boundary of the formability range (so does the other boundary of shape-fixability range). The other boundary of the formability range is associated to the corresponding stamping defect criterion. Putting a stamping defect criterion and the associated safety factor and the other boundary together, formability diagrams for each stamping defect concern are established. Finally, the data of the formability diagrams are sent to blocks of 16 and 20 respectively.

In block 16, formability indexes for each stamping defect concern are calculated by using the mechanics data from block 14. For each type of stamping defect concerns, the deformation region/zone-based formability indexes are calculated. Formability indexes of anti-fracturability and anti-edge-fracturability are directly calculated in each deformation zone by using the mechanics data from block 14 and their corresponding stamping defect criteria from block 18. Formability indexes of anti-wrinklability, shape-fixability, stretchability and anti-bucklability are directly calculated by using the mechanics data from block 14. Finally, the data of the formability indexes are sent to block 20.

In block 20, the formability status for each stamping defect concern is identified. There are two types of input data in block 20: (a) the data of the formability indexes from block 16, and (b) the data of formability diagrams from block 18. The formability index for each stamping defect concern in the formed workpiece is compared with the corresponding formability diagram. If this formability index is in the safe zone of the formability diagram, the formability status for this stamping defect concern is safe. If it is in the marginal or the failure zone of the formability diagram, the formability status is unsafe. All the data of the formability indexes with safe status are sent to block 22; and the data of the rest formability indexes with unsafe status are sent to block 24 for developing formability solutions respectively.

In block 22, reliability range of the stamping process is established. The reliability range is quantified with a stamping process window including formability, material and tooling windows. Differences between the boundary of formability range near the stamping defect criterion and the formability indexes are calculated as operational formability ranges for each stamping defect concern. Putting all the operational formability ranges together establishes the formability window. After the formability window is established, transforming it into the range of the material properties of sheet metal establishes the material window, and transforming it into the range of the other six types of stamping variables establishes the tooling window. Finally, using the formability, material and tooling windows constructs the stamping process window (SPW). The SPW is one type of the formability solutions. It is applied for the stability control of a stamping process to make qualified parts.

In block 24, solutions for the stamping defects are developed. Amounts of metal flow adjustments for solving each stamping defect are shown as a range of strains and/or displacements. The ranges of metal flow adjustments are obtained through calculating the differences between the formability indexes and the chosen extreme values governed by the formability ranges. These ranges of metal flow adjustments are then verified by using the characteristics of deformation regions/zones. Finally, these ranges are transformed into a domain of stamping variables, which are used to implement the metal flow adjustments. Putting all the ranges of metal flow adjustments and the domain of stamping variables together, the solutions for the stamping defects are developed. They are another type of formability solutions. If there are no stamping defects in the formed workpiece, do not perform the process of block 24.

Being different from the present formability analyses, using the universal formability technology, the invention can develop an effective and accurate formability solution for all of the six types of stamping defect concerns in a formed workpiece. The formability solution has the consistent and unique format. Ranges of formability indexes quantify both the reliability in the safe formability status and the metal flow adjustment for solving a stamping defect in the unsafe formability status. The ranges of formability indexes are further transformed into domains of stamping variables for implementing the formability solution.

Formability Analysis I: Anti-Fracturability

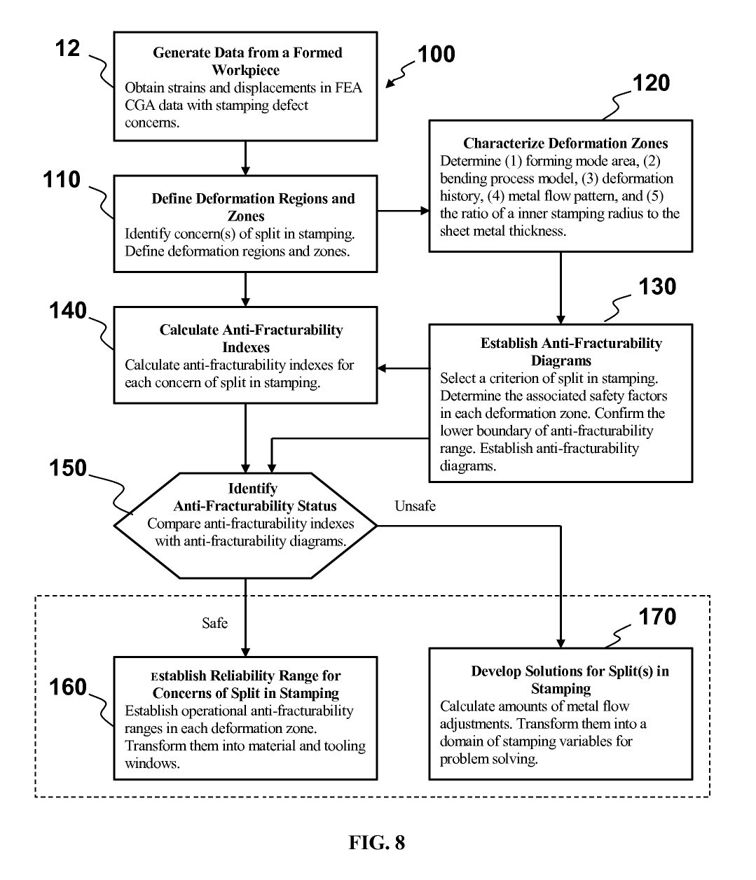

Referencing FIG. 8, the anti-fracturability analysis method 100 for concerns of split in stamping with UFT by using FEA and CGA is shown. In block 110, deformation regions and zones are defined using the mechanics data from block 12. Firstly, every element/deformed circle where its deformation is 50% or more of deformation capacity of a sheet metal is identified. Here, the deformation in the element/deformed circle is quantified by the equivalent strain. The deformation capacity (DC) of a sheet metal is defined as the equivalent strain on the forming limit curve (FLC) at the linear straining path of the element/deformed circle. FLC is the criterion of split in stamping. It is directly selected from the database of stamping defect criteria in block 130 by using material grade and thickness of the sheet metal. These elements/deformed circles in the formed workpiece are divided into several groups. Elements/deformed circles in each group are adjacent to each other and are defined as a deformation region. Second, in each deformation region, find the element/deformed circle with the maximum deformation and other elements/deformed circles whose deformations are within the strain measurement error. These elements/deformed circles belong to one or more clusters. The elements/deformed circles in each cluster are adjacent to each other and are constructed into a deformation zone. When a deformation zone belongs to a stamping area, its dimension is measured by using the major and minor axes of its curved enveloping ellipse; when the deformation zone belongs to a stamping radius, its dimension is measured by using the length of its generating line. Finally, the deformation regions and zones with the associated mechanics data and dimensions are sent to blocks of 120 and 140 respectively.

In block 120, the deformation zones are characterized using the data from block 110. When a deformation zone belongs to a stamping area, conduct qualitative analyses including (a) forming mode area, (b) deformation history, and (c) metal flow pattern. When it belongs to a stamping radius, find out (a) bending process model, (b) metal flow pattern, and (c) the ratio of the inner stamping radius to the sheet metal thickness. The obtained mechanics properties in all of the deformation zones are applied for verifying the selected criterion of split in stamping, determining the refinement factors in the safety factors and solving splits in stamping. The data of the obtained mechanics properties are sent to blocks of 130.

In block 130, anti-fracturability diagrams are generated for each concern of split in stamping in each deformation zone. First of all, based on the material grade and thickness of sheet metal, the criterion of split in stamping (FLC) for the whole formed workpiece is selected from the database of stamping defect criteria. Using the mechanics properties from block 120 verifies this selected criterion and confirms the associated lower boundary of anti-fracturability range. Safety factors (ΔRCMD) in each deformation zone is equal to the constant safety factor (ΔRCMDₒ) plus a refinement factor (δRCMD):

ΔRCMD=ΔRCMDₒ+δRCMD

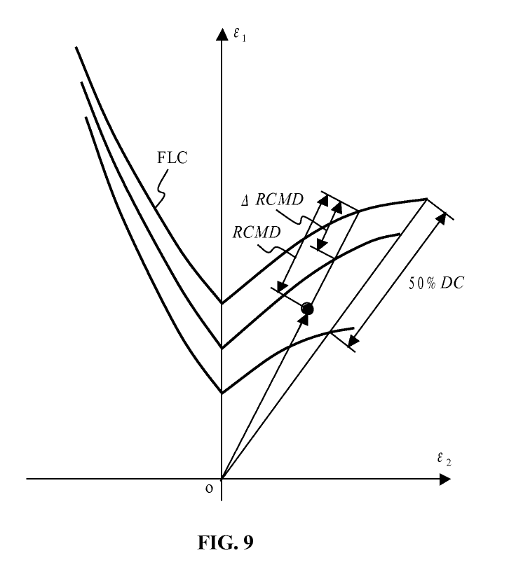

Based on the data of the mechanics properties that come from block 120, the refinement factors are determined in each deformation zone. The constant safety factor (ΔRCMDₒ) can also be used alone when the refinement factor is zero. Putting each safety factor, the FLC and the associated lower boundary of anti-fracturability range together, anti-fracturability diagrams for each concern of split in stamping are established, as shown in FIG. 9. Finally, the data of the anti-fracturability diagrams are sent to blocks of 140 and 150 respectively.

In block 140, anti-fracturability indexes for each concern of split in stamping are calculated using the data from block 110. The anti-fracturability index is calculated at the element/deformed circle with the maximum deformation in each deformation zone. Firstly, calculate the deformation at this element/deformed circle with the maximum deformation by using the equivalent strain:

$${ɛ}_{e} = \frac{\sqrt{1 + R}}{1 + 2 R} \sqrt{{R ( {ɛ}_{1} - {ɛ}_{2} )}^{2} + {( {ɛ}_{2} - R {ɛ}_{3} )}^{2} + {( R {ɛ}_{3} + {ɛ}_{1} )}^{2}}$$

The linear straining path at this element/deformed circle is found out based on the ratio of the minor to the major strain as shown in FIG. 9. Secondly, extending the linear straining path determines the deformation capacity (DC) of the sheet metal on the FLC as

$$DC = \frac{\sqrt{1 + R}}{1 + 2 R} \sqrt{{R ( {ɛ}_{1}^{DC} + {ɛ}_{2}^{DC} )}^{2} + {( {ɛ}_{2}^{DC} - R {ɛ}_{3}^{DC} )}^{2} + {( R {ɛ}_{3}^{DC} - {ɛ}_{1}^{DC} )}^{2}}$$

Finally, the anti-fracturability index RCMD is calculated as

RCMD=DC−εₑ

The data of the anti-fracturability indexes for each concern of split in stamping are sent to block 150.

In block 150, the anti-fracturability status for each concern of split in stamping is identified. Comparing the anti-fracturability index from block 140 with the corresponding anti-fracturability diagram from block 130 for each concern of split in stamping, the anti-fracturability status for each concern of split in stamping is determined. When RCMD>ΔRCMD, the status is safe. When RCMD≦ΔRCMD, it is unsafe as shown in FIG. 9. All the data of the anti-fracturability indexes with safe status are sent to block 160; and the data of the rest anti-fracturability indexes with unsafe status are sent to block 170.

In block 160, the reliability range of the stamping process regarding the concerns of split in stamping is established. Using the data from block 150, the difference (RCMD−ΔRCMD) is calculated as the operational anti-fracturability range for each concern of split in stamping. After all the operational anti-fracturability ranges are established, transforming these ranges into (a) a domain of the material properties of the sheet metal establishes a part of the material window, and (b) a domain of the other six types of stamping variables establishes a part of the tooling window. Finally, putting the operational anti-fracturability ranges, partial material and tooling windows together, a part of the stamping process window is established. The partial SPW is applied for the stability control of the stamping process in regard to the concerns of splits in stamping. It is one type of the anti-fracturability solutions.

In block 170, solutions for the splits in stamping are developed. The input data from block 150 are used to calculate the amounts of metal flow adjustments for solving the splits. Take (ΔRCMD−RCMD) as the minimum amount of metal flow adjustment, and (50% DC−RCMD) as the maximum amount of metal flow adjustment for each split in stamping in each deformation zone. After the ranges of metal flow adjustments for each split in stamping are calculated, using the data of the mechanics properties in the deformation zones refines and confirms the ranges of metal flow adjustments. These ranges are then transformed into a domain of stamping variables, which are used to implement the metal flow adjustments. Putting the ranges of metal flow adjustments and the domain of the stamping variables together, the solutions for the splits in stamping are developed. They are another type of the anti-fracturability solutions. If there are no splits in the formed workpiece, the process of block 170 described above is skipped.

Formability Analysis II: Anti-Edge-Fracturability

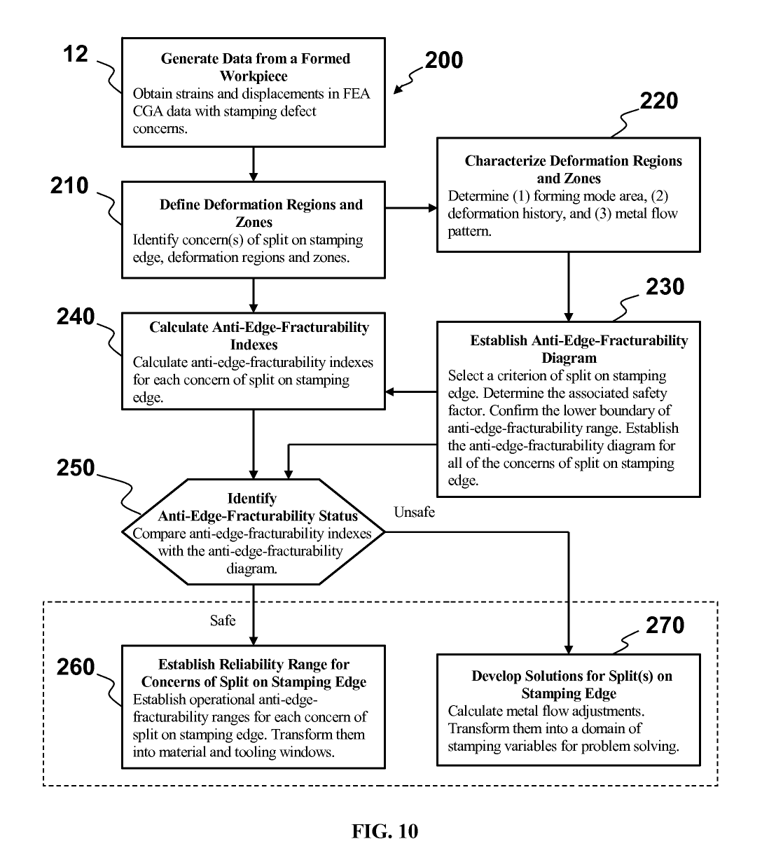

Referencing FIG. 10, the anti-edge-fracturability analysis method 200 for concerns of split on stamping edge with UFT by using FEA and CGA is shown. In block 210, deformation regions are defined using the mechanics data that come from block 12. The existence of a deformation region is determined based on (a) where there exists a straight or concave edge segment of a sheet metal blank, and (b) where the major strain (ε₁) in the element/deformed circle with the maximum deformation is parallel to the straight or concave edge and is equal to or more than 50% of the deformation capacity near blank edge. Here, the deformation capacity (DCₑ) near blank edge is equal to the strain on the criterion of split on stamping edge with this blank edge condition. The blank edge condition is quantified with the range of relative burr height of the sheet metal blank. The DCₑ is directly selected from the database of stamping defect criteria in block 230. The major strain (ε₁) is used to quantify deformation in each element/deformed circle. The element/deformed circle with the maximum deformation is identified first. Then, starting this element/deformed circle, elements/deformed circles, where ε₁≧50% DCₑ, which are adjacent to each other and whose strain states are the same as or similar to that of this element/deformed circle, are found out. Putting all of the elements/deformed circles together, a deformation region that is partially bound by the straight or concave blank edge segment is determined. Furthermore, starting this element/deformed circle with the maximum deformation, all adjacent elements/deformed circles within the strain measurement error are identified and constructed as a deformation zone. Finally, the deformation regions and zones with the associated mechanics data are sent to blocks of 220 and 240.

In block 220, the deformation regions and zones are characterized using the data from block 210. In each deformation region, determine forming mode areas. In the deformation zone, determine (a) deformation history, and (b) metal flow pattern. The obtained mechanics properties in all of the deformation regions and zones are applied for verifying the selection of criterion of split on stamping edge and solving the splits on stamping edge. The data of the obtained mechanics properties in conjunction with the range of the ratio of the burr height to the sheet metal thickness are sent to block 230.

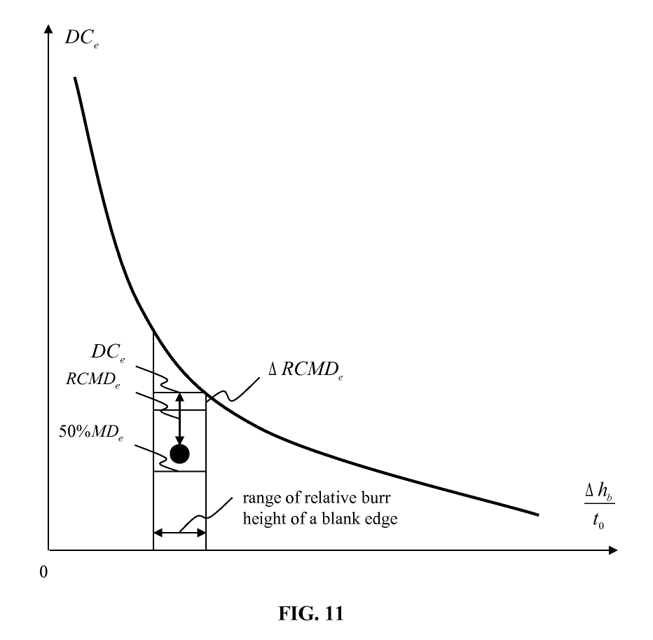

In block 230, the anti-edge-fracturability diagram is generated for each concern of split on stamping edge. First of all, based on the material grade and thickness of sheet metal, the criterion of split on stamping edge is selected from the database of stamping defect criteria. Using the mechanics properties from block 220 verifies this selection. Based on the range of the relative burr height, the deformation capacity (DCₑ) near blank edge is determined on the criterion of split on stamping edge. The safety factor (ΔRCMDₑ) in each deformation zone is a constant. It is allocated on the upper boundary of the range of the relative burr height. The lower boundary of anti-edge-fracturability range is confirmed as 50% DCₑ. Putting the criterion of split on stamping edge, the safety factor and the lower boundary of anti-edge-fracturability range together, the anti-edge-fracturability diagram for all concerns of split on stamping edge is established as shown in FIG. 11. Finally, the data of the anti-edge-fracturability diagram are sent to blocks of 240 and 250 respectively.

In block 240, anti-edge-fracturability indexes for each concern of split on stamping edge are calculated by using the data from block 210 and 230. The major strain (ε₁) at the element/deformed circle with the maximum deformation is directly used for the calculation of the anti-edge-fracturability indexes. The anti-fracturability index (RCMDₑ) is defined as the difference between DCₑ and ε₁ and calculated by

RCMDₑ=DCₑ−ε₁

The data of the anti-fracturability indexes for each concern of split on stamping edge are then sent to block 250.

In block 250, the anti-edge-fracturability status for each concern of split on stamping edge is identified. Comparing the anti-edge-fracturability index from block 240 with the anti-edge-fracturability diagram from block 230, the anti-edge-fracturability status for each concern of split on stamping edge is determined. When RCMDₑ>ΔRCMDₑ, the status is safe; when RCMDₑ≦ΔRCMDₑ, it is unsafe as illustrated in FIG. 11. All the data of the anti-edge-fracturability indexes with safe status are sent to block 260; and the data of the rest anti-edge-fracturability indexes with unsafe status are sent to block 270.

In block 260, the reliability range of the stamping process regarding the concerns of split on stamping edge is established. By using the data from block 250, the difference (RCMDₑ−ΔRCMDₑ) is calculated as the operational anti-edge-fracturability ranges for each concern of split on stamping edge. After all the operational anti-edge-fracturability ranges are determined, transforming these ranges into (a) a domain of the material properties of the sheet metal establishes a part of the material window, and (b) a domain of the other six types of stamping variables establishes a part of the tooling window. Finally, putting the operational anti-edge-fracturability ranges and partial material and tooling windows together, a part of the stamping process window is established. The partial SPW is applied for the stability control of the stamping process regarding the concerns of split on stamping edge. This is one type of the anti-edge-fracturability solutions.

In block 270, solutions for the splits on stamping edge are developed. The input data from block 250 are used to calculate the amounts of metal flow adjustments for solving the splits on stamping edge. Use (ΔRCMDₑ−RCMDₑ) as the minimum amount of metal flow adjustment, and (50% DCₑ−RCMDₑ) as the maximum amount of metal flow adjustment for each split on stamping edge. After the ranges of metal flow adjustments for each split on stamping edge are calculated, using the data of the mechanics properties in the deformation zones refines and confirms the ranges of metal flow adjustments. These ranges are then transformed into a domain of stamping variables, which are used to implement the metal flow adjustments. Putting the ranges of metal flow adjustments and the domain of stamping variables together, the solutions for the splits on stamping edge are developed. The solutions are another type of anti-edge-fracturability solutions. If there are no splits on stamping edge in the formed workpiece, this process of the block 270 is skipped.

Formability Analysis III: Anti-Wrinklability

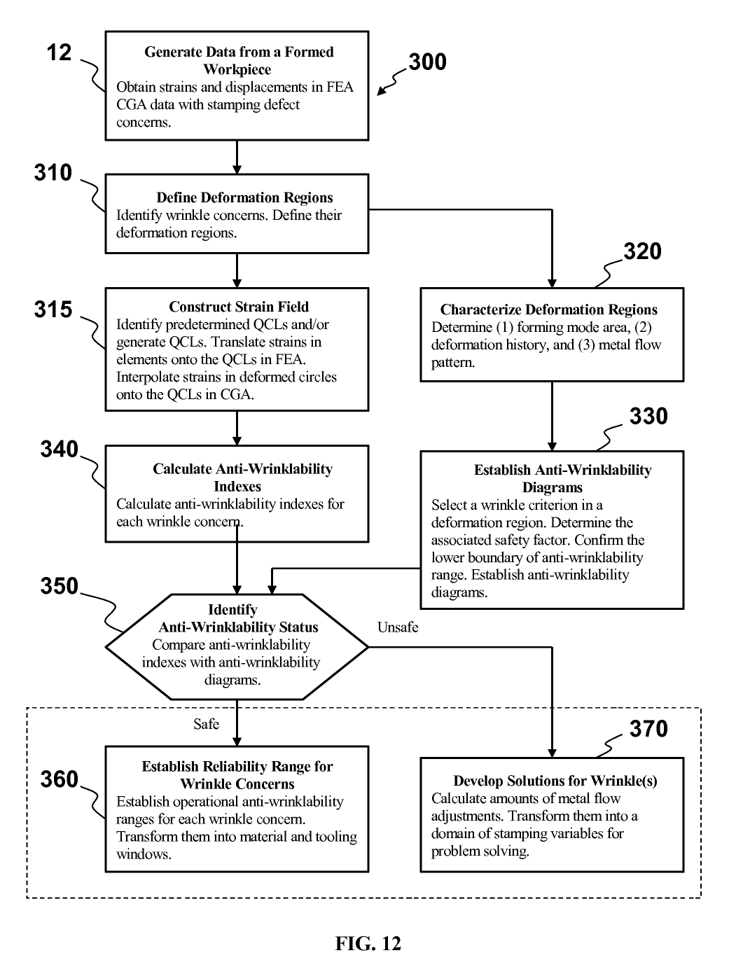

Referencing FIG. 12, the anti-wrinklability analysis method 300 for wrinkle concerns with UFT by using FEA and CGA is shown. In block 310, the deformation regions are defined using the mechanics data that comes from block 12. The existence of a deformation region is determined based on the existing elements/deformed circles where ε₂<0 and

$${ɛ}_{2} \leq - \frac{1}{2} {ɛ}_{1} .$$

These elements/deformed circles are divided into several groups. Elements/deformed circles in each group are adjacent to each other and are constructed into a deformation region. The deformation regions with the associated mechanics data are sent to blocks of 315 and 320.

In block 320, the deformation regions are characterized using the data from block 310. In each deformation region, determine (a) forming mode areas, (b) deformation history, and (c) metal flow pattern. The obtained mechanics properties in all of the deformation regions are applied for verifying the selection of wrinkle criteria and solving wrinkles. The data of the obtained mechanics properties are sent to block 330.

In block 330, anti-wrinklability diagrams are established for each wrinkle concern. Firstly, the wrinkle criterion is selected from the database of stamping defect criteria, then, position the wrinkle criterion in the wrinkle spectrum based on its wrinkle height (Δh_{w}). Here, the wrinkle height (Δh_{w}) in a deformation region is defined as the distance between the reference surface and the highest wrinkle in the normal direction. Using the mechanics properties in the deformation region verifies the selection of the wrinkle criterion. Secondly, based on the magnitude of wrinkle height of the wrinkle criterion, the corresponding measurement method of the wrinkle height is selected; the associated measurement error is determined and taken as the safety factor. Thirdly, confirm the mechanical “zero” as the lower boundary of anti-wrinklability range

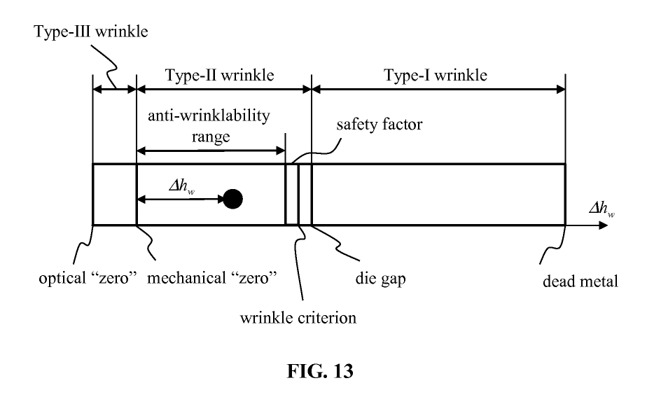

Fourthly, putting the wrinkle criterion, the associated safety factor, and the lower boundary of anti-wrinklability range together, anti-wrinklability diagrams for each wrinkle concern are established as illustrated in FIG. 13. This establishing procedure of the anti-wrinklability diagrams is applied for the Type-I and -II wrinkle concerns, not for Type-III wrinkle concerns. Finally, the data of the anti-wrinklability diagrams are sent to blocks 350.

In block 315, the original deformation field in the formed workpiece is structured. In FEA, map all of the predetermined QCLs onto the formed workpiece in the postprocessor. For a wrinkle concern with 10% or more equivalent strains in a deformation region, a locus of minor strains is generated at the minor strain direction of the element with the wrinkle height in the deformation region of the formed workpiece. After the locus is smoothed, it is taken as the QCL in the deformation region. Strains along the QCLs are directly obtained from elements that meet them. In CGA, QCLs are directly marked on the formed workpiece. Major and minor strains on deformed circles that meet or are near the QCLs are interpolated onto the QCLs by using following formulas:

$$\{ \begin{matrix}{ɛ}_{1}^{( i )} = {ɛ}_{1}^{′} + \frac{{l}^{′}}{{l}^{′} + {l}^{″}} ( {ɛ}_{1}^{″} - {ɛ}_{1}^{′} ) \\ {ɛ}_{2}^{( i )} = {ɛ}_{2}^{′} + \frac{{l}^{′}}{{l}^{′} + {l}^{″}} ( {ɛ}_{2}^{″} - {ɛ}_{2}^{′} ) \\ {θ}^{( i )} = {θ}^{′} + \frac{{l}^{′}}{{l}^{′} + {l}^{″}} ( {θ}^{″} - {θ}^{′} )\end{matrix}$$

When a wrinkle concern is located in the deformation region with 10% or more equivalent strains, starting the deformed circle with the wrinkle height in the minor strain direction, a smoothed locus is directly marked on the deformation region as the QCL. Major and minor strains on the QCL are directly obtained from deformed circles that meet the QCL. Finally, the data of the structured strain field in each deformation region are sent to block 340.

In block 340, anti-wrinklability indexes for each wrinkle concern are calculated using the data from block 315. Anti-wrinklability indexes in each deformation region include both the wrinkle height and strain gradients. The wrinkle height (Δh_{w}) in each deformation region is directly obtained from the mechanics data. The strain gradients include major, minor and major strain direction gradient. They are calculated by using

$$\{ \begin{matrix}{grad}^{( i )} ( {ɛ}_{qcl1} ) = \frac{{ɛ}_{1}^{( i )} - {ɛ}_{1}^{( i + 1 )}}{Δ {l}^{( i )}} \\ {grad}^{( i )} ( {ɛ}_{qcl2} ) = \frac{{ɛ}_{2}^{( i )} - {ɛ}_{2}^{( i + 1 )}}{Δ {l}^{( i )}} \\ {grad}^{( i )} ( {θ}_{qcl} ) = \frac{{θ}^{( i )} - {θ}^{( i + 1 )}}{Δ {l}^{( i )}}\end{matrix}$$

In case of a deformation region with 10% or more equivalent strains, only the minor strain gradient is calculated. Finally, the data of the anti-wrinklavility indexes are sent to block 350.

In block 350, the anti-wrinklability status for each wrinkle concern is identified. Only the wrinkle height (Δh_{w}) is used for determining the anti-wrinklability status. Strain gradients are taken as the properties of the anti-wrinklability status in each deformation region. Comparing Δh_{w} from block 340 with the corresponding anti-wrinklability diagram from block 330, the anti-wrinklability status for each wrinkle concern is determined. When the wrinkle height is less than the upper boundary of anti-wrinklability range, the status is safe; otherwise, it is unsafe as illustrated in FIG. 13. All the data of the anti-wrinklability indexes with safe status are sent to block 360; and the data of the rest anti-wrinklability indexes with unsafe status are sent to block 370.

In block 360, the reliability range of the stamping process regarding the wrinkle concerns is established. The difference between the wrinkle height and the upper boundary of anti-wrinklability is calculated as the operational anti-wrinklability range for each wrinkle concern. The associated strain gradients are taken as the properties of the safe anti-wrinklability status. After all the operational anti-wrinklability ranges are established, these ranges are transformed into (a) a domain of the material properties of the sheet metal to establish a part of the material window, and (b) a domain of the other six types of stamping variables to establish a part of the tooling window. Finally, putting the operational anti-wrinklability ranges, partial material and tooling windows together, a part of the stamping process window is established. The partial SPW is applied for the stability control of the stamping process regarding the wrinkle concerns. It is one type of the anti-wrinklability solutions.

In block 370, solutions for the wrinkles are developed. The input data of the anti-wrinklability indexes with unsafe status from block 350 are used to calculate amounts of metal flow adjustments. The amounts of metal flow adjustments for solving the wrinkles are quantified by displacement differences along chosen QCLs. After a QCL is chosen, use the displacement difference (Δuₘᵢₙ=u^{c}−u) along it between the current case and the critical instability with the compression strain (ε^{c}) as the minimum amount of metal flow adjustment, and the displacement difference (Δuₘₐₓ=u^{t}−u) between the current case and the tension strain threshold (ε^{t}) as the maximum amount of metal flow adjustment. Here, u is the current displacement along the QCL; u^{c} is the displacement when the QCL has the critical instability with the compression strain ε^{c}; and u^{t} is the displacement when the QCL is stretched to ε^{t}. They are calculated by

$$\{ \begin{matrix}u = {\sum }_{i = 1}^{n} \frac{{ɛ}_{j}^{( i )} + {ɛ}_{j}^{( i - 1 )}}{2} Δ {l}^{( i )} \\ {u}^{c} = {ɛ}^{c} {\sum }_{i = 1}^{n} Δ {l}^{( i )} \\ {u}^{t} = {ɛ}^{t} {\sum }_{i = 1}^{n} Δ {l}^{( i )}\end{matrix}$$

After the ranges of metal flow adjustments for each wrinkle are calculated, the data of the mechanics properties in the deformation regions are used to refine and confirm the ranges of metal flow adjustments. These ranges are then transformed into a domain of stamping variables, which are used to implement the metal flow adjustments. Putting the ranges of metal flow adjustments and the domain of stamping variables together, the solutions for the wrinkles are developed. They are another type of the anti-wrinklability solutions. If there are no wrinkles in the formed workpiece, skip this step in block 370.

Formability Analysis IV: Shape-Fixability

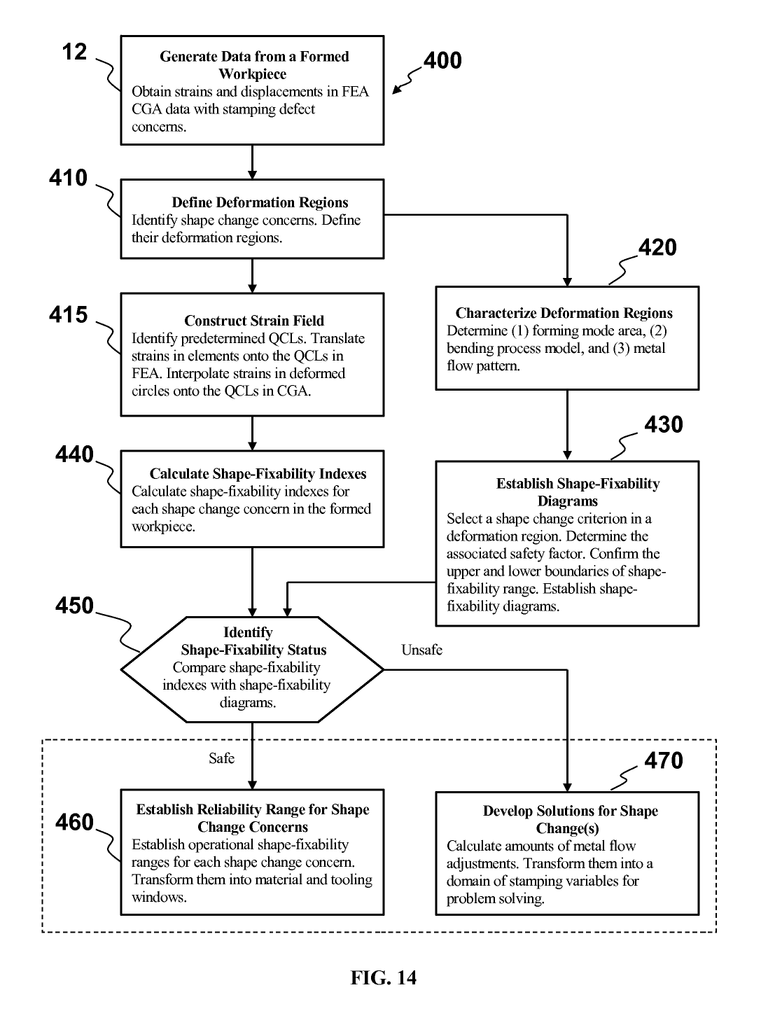

Referencing FIG. 14, the shape-fixability analysis method 400 for shape change concerns with UFT by using FEA and CGA is shown. In block 410, predetermined deformation regions in FEA model in the preprocessor are mapped onto the formed workpiece that comes from block 12 in the postprocessor. In CGA, predetermined deformation regions are directly marked on the formed workpiece. The deformation regions with the associated mechanics data are then sent to blocks of 415 and 420 respectively.

In block 420, the deformation regions are characterized using the data from block 410. In each deformation region, determine (a) forming mode areas when it belongs to a stamping area, (b) bending process model when it belongs to a stamping radius, and (c) metal flow pattern.

The obtained mechanics properties in all of the deformation regions are applied for refining and verifying the safety factor of shape-fixability diagram and solving the shape changes. The data of the obtained mechanical properties are sent to block 430.

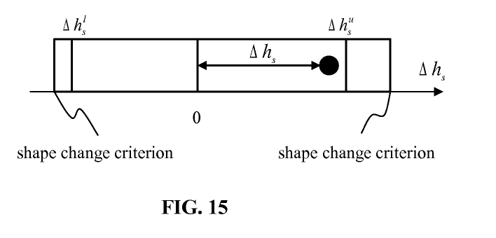

In block 430, shape-fixability diagrams are generated for each shape change concern. Based on the product specification of each deformation region, shape change criteria are selected from the database of stamping defect criteria. The corresponding control limits of shape change are determined and then taken as the upper and lower boundaries of shape-fixability range directly. The safety factors are defined by the differences between the shape change criteria and the control limits of shape change. Using the mechanics properties in each deformation region refines and verifies the selected safety factors. Putting the shape change criterion and the corresponding safety factors together, shape-fixability diagrams for each shape change concern are established as illustrated in FIG. 15. Finally, the data of the shape-fixability diagrams are sent to block 450.

In block 415, the original deformation field in the formed workpiece is structured. In FEA, map all of the predetermined QCLs onto the formed workpiece in the postprocessor. Strains along these QCLs in each deformation region are directly obtained from elements that meet them. In CGA, the predetermined QCLs are directly marked on the formed workpiece. Strains on deformed circles that meet or are near these QCLs are interpolated onto the QCLs by using the same formulae in block 315. Finally, the data of the structured strain field are sent to block 440.

In block 440, shape-fixability indexes for each shape change concern are calculated using the data from block 415. Shape-fixability indexes in each deformation region include both the normal displacement and strain gradients. The normal displacement (Δhₛ) in each deformation region is defined as the maximum value among normal displacements at predetermined positions on the QCLs. It is directly obtained from the mechanics data. The strain gradients include major, minor and major strain direction gradient. They are calculated by using the same formulae in block 340. Finally, the data of the shape-fixability indexes are sent to block 450.

In block 450, the shape-fixability status for each shape change concern is identified. Only the normal displacement (Δhₛ) is used for determining the shape-fixability status. The strain gradients are taken as the properties of the shape-fixability status in each deformation region. Comparing Δhₛ with the corresponding shape-fixability diagram, the shape-fixability status for each shape change concern is determined. When Δhₛ<Δhₛ^{u} and Δhₛ>Δhₛ^{l}, the shape-fixability status is safe; otherwise, it is unsafe as illustrated in FIG. 15. Here, Δhₛ^{u} and Δhₛ¹ are the upper and lower boundary of shape-fixability respectively. All the data of the shape-fixability indexes with safe status are sent to block 460; and the data of the rest shape-fixability indexes with unsafe status are sent to block 470.

In block 460, the reliability range of the stamping process regarding the shape change concerns is established. The differences between the shape-fixability indexes and the shape-fixability criterion in the same side are calculated as the operational shape-fixability ranges for each shape change concern. The associated strain gradients are taken as the properties of the safe shape-fixability status. After all the operational shape-fixability ranges in each deformation region are determined, transforming these ranges into (a) a domain of the material properties of the sheet metal establishes a part of the material window, and (b) a domain of the other six types of stamping variables establishes a part of the tooling window. Finally, putting the operational shape-fixability ranges and partial material and tooling windows together, a part of the stamping process window is established. The partial SPW is applied for the stability control of the stamping process regarding the shape change concerns. It is one type of the shape-fixability solutions.

In block 470, solutions for the shape changes are developed. The amounts of metal flow adjustments for solving the shape changes are quantified by displacement differences between the current displacement (u) and the maximum/minimum displacement (uₘₐₓ/uₘᵢₙ) along QCLs. They are calculated by

$$\{ \begin{matrix}u = {\sum }_{i = 1}^{n} \frac{{ɛ}_{j}^{( i )} + {ɛ}_{j}^{( i - 1 )}}{2} Δ {l}^{( i )} \\ {u}_{min} = {ɛ}_{min} {\sum }_{i = 1}^{n} Δ {l}^{( i )} \\ {u}_{max} = {ɛ}_{max} {\sum }_{i = 1}^{n} Δ {l}^{( i )}\end{matrix}$$

After a QCL is chosen, use the displacement difference (uₘₐₓ=uₘₐₓ−u) along the QCL as the maximum amount of metal flow adjustment, and the displacement difference (Δuₘᵢₙ=u−uₘᵢₙ) along the QCL as the minimum amount of metal flow adjustment. When a metal flow has opposite directions in two segments along a chosen QCL, Use the above formulae to calculate displacements in each QCL segment individually. After the ranges of metal flow adjustments for each shape change are calculated, the data of the mechanics properties in the deformation regions are used to refine and confirm the ranges of metal flow adjustments. These ranges are then transformed into a domain of stamping variables, which are used to implement the metal flow adjustments. Putting the ranges of metal flow adjustments and the domain of stamping variables together, the solutions for the shape changes are developed. They are another type of the shape-fixability solutions. If there are no shape changes in the formed workpiece, this function block 470 is skipped.

Formability Analysis V: Stretchability

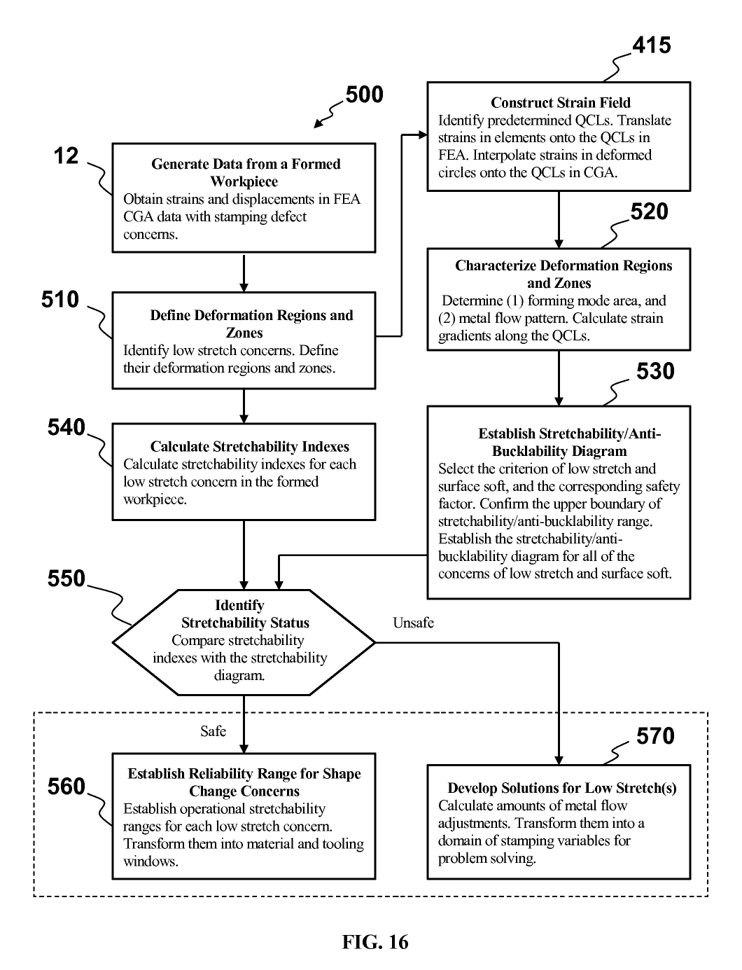

Referencing FIG. 16, the stretchability analysis method 500 for low stretch concerns with UFT by using FEA and CGA is shown. In block 510, the predetermined deformation regions are identified; deformation zones in each deformation region are then determined. Each predetermined deformation region belongs to a stamping area. In FEA, the predetermined deformation regions in FEA model in the preprocessor are mapped onto the formed workpiece in the postprocessor. In CGA, the predetermined deformation regions are directly marked on the formed workpiece. In each deformation region, find out the element/deformed circle with the minimum deformation and other elements/deformed circles whose deformations are within the strain measurement error.

These elements/deformed circles belong to one or more groups. The elements/deformed circles in each group are adjacent to each other and are constructed into a deformation zone. Its dimension is measured on the major and minor axes of its curved enveloping ellipse. Finally, the deformation regions and zones with the associated mechanics data are sent to blocks of 415 and 540 respectively.

In block 520, the deformation regions and zones are characterized using the data from block 415. The original deformation field in the formed workpiece is structured in block 415. The structured strain field and the mechanics data are sent to block 520. In each deformation region, determine forming mode area, and calculate the major and minor strain gradients along chosen QCLs by using the formulae in block 340. In each deformation zone, determine metal flow pattern. The obtained mechanics properties in all of the deformation regions and zones are applied for verifying the selection of the criterion of low stretch and surface soft and solving low stretches. The data of the obtained mechanics properties are sent to block 530.

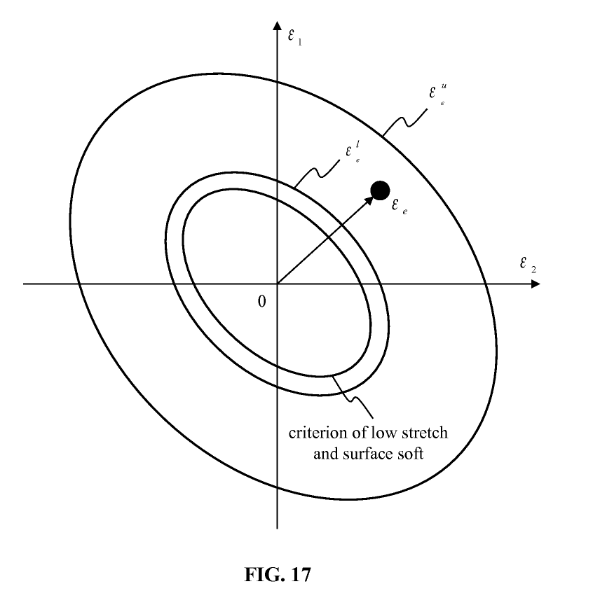

In block 530, the stretchability/anti-bucklability diagram is established for all concerns of low stretches and surface soft. Only one stretchability/anti-bucklability diagram is needed for stretchability and/or anti-bucklability analysis in the whole formed workpiece. Based on the material grade and thickness of the sheet metal, a criterion of low stretch and surface soft is selected from the database of stamping defect criteria. Using the mechanics properties in each deformation region, which come from block 520, verifies the selection of the criterion of low stretch and surface soft. The safety factor is then chosen based on the strain measurement error. The upper boundary (εₑ^{u}) of stretchability/anti-bucklability range is determined with the maximum possible strain in each deformation region. Putting the criterion of low stretch and surface soft, the corresponding safety factor and the upper boundary of stretchability/anti-bucklability range together, the stretchability/anti-bucklability diagram for all concerns of low stretches and/or surface soft is established as illustrated in FIG. 17. Finally, the data of the stretchability/anti-bucklability diagram are sent to block 550.

In block 540, stretchability indexes for each low stretch concern are calculated using the data from block 510. The stretchability indexes are calculated by the equivalent strain at the element/deformed circle with the minimum deformation in each deformation zone. In CGA, it is calculated by:

$${ɛ}_{e} = \frac{\sqrt{1 + R}}{1 + 2 R} \sqrt{{R ( {ɛ}_{1} - {ɛ}_{2} )}^{2} + {[ R {ɛ}_{1} + ( 1 + R ) {ɛ}_{2} ]}^{2} + {[ ( 1 + R ) {ɛ}_{1} + {ɛ}_{2} ]}^{2}}$$

In FEA, it is calculated by using either this formula or the other formula in block 140. Finally, the data of the stretchability indexes for each low stretch concern in the formed workpiece are sent to block 550.

In block 550, the stretchability status for each low stretch concern is identified. Comparing the equivalent strain (εₑ) from block 540 with the stretchability diagram from block 530, the stretchability status for each low stretch concern is determined. When εₑ>εₑ^{l}, the stretchability status is safe; when εₑ≦εₑ^{l},it is unsafe (FIG. 17). Here, εₑ^{l} is the lower boundary of stretchability/anti-bucklability range. All the data of the stretchability indexes with safe status are sent to block 560; and the data of the rest stretchability indexes with unsafe status are sent to block 570.

In block 560, the reliability range of the stamping process regarding the low stretch concerns is established. The difference (εₑ−εₑ^{l}) is calculated as the operational stretchability range for each of the low stretch concerns. After all the operational stretchability ranges in each deformation zone are calculated, refine and confirm these ranges by using the mechanics properties in the deformation regions/zones. Then, transforming these ranges into (a) a domain of the material properties of the sheet metal establishes a part of the material window, and (b) a domain of the other six types of stamping variables establishes a part of the tooling window. Finally, putting the operational stretchability ranges and partial material and tooling windows together, a part of the stamping process window is established. The partial SPW is applied for the stability control of the stamping process regarding the low stretch concerns. It is one type of the stretchability solutions.

In block 570, solutions for the low stretches are developed. Amounts of metal flow adjustments for solving the low stretches are quantified by using the difference between the current stretchability index and the boundaries of stretchability range. Take (εₑ^{u}−εₑ) as the maximum amount of metal flow adjustment, and (εₑ^{l}−εₑ) as the minimum amount of metal flow adjustment for each low stretch. After the ranges of metal flow adjustments for each low stretch in the formed workpiece are calculated, the data of the mechanics properties in the deformation regions and zones are used to refine and confirm the ranges of metal flow adjustments. The ranges of metal flow adjustments can be further transformed into the ranges of displacements by applying the same procedure and the formulae in block 470. These ranges are then transformed into a domain of stamping variables, which are used to implement the metal flow adjustments. Putting the ranges of metal flow adjustments or displacements and the domain of stamping variables together, the solutions for the low stretches are developed. They are another type of the stretchability solutions. If there are no low stretches in the formed workpiece, this function block 570 is skipped.

Formability Analysis VI: Anti-Bucklability

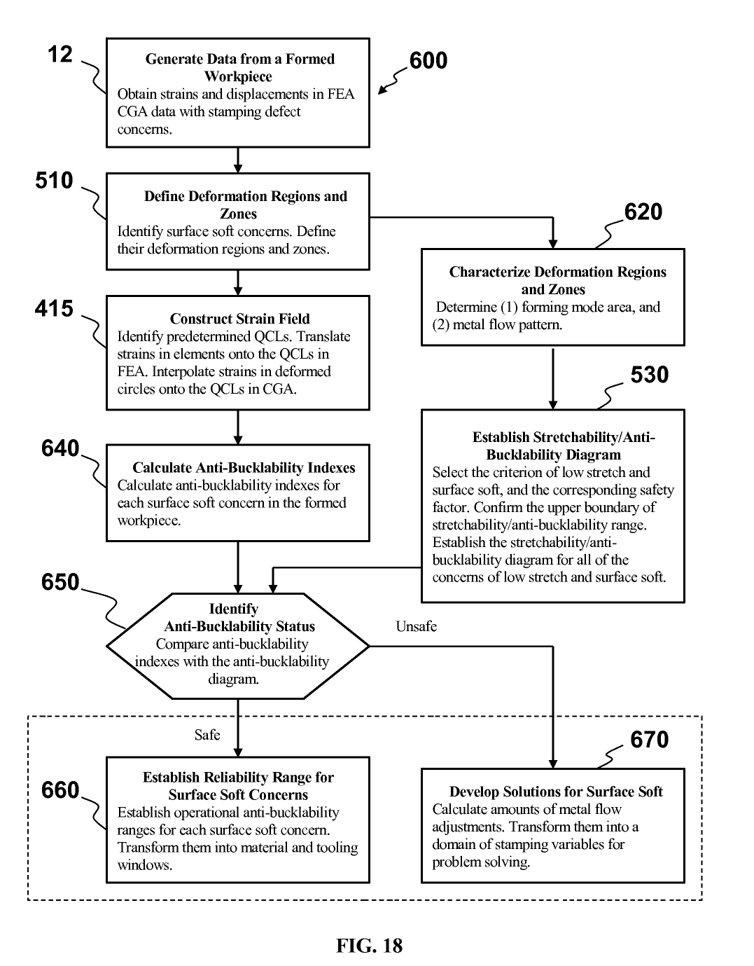

Referencing FIG. 18, the anti-bucklability analysis method 600 for surface soft concerns with UFT by using FEA and CGA is shown. Deformation regions and zones in the formed workpiece are defined in block 510 by using the mechanics data from block 12. The deformation regions and zones with the associated mechanics data are then sent to blocks of 415 and 620 respectively. In block 415, the original deformation field in the formed workpiece is structured by using the input data from block 510. Then, the data of the structured strain field are sent to block 640.

In block 620, the deformation regions and zones are characterized using the data from block 510. In each deformation region, determine forming mode areas; in each deformation zone, determine its metal flow pattern. The obtained mechanics properties in all of the deformation regions and zones are applied for verifying the selection of the criterion of low stretch and surface soft and solving surface soft. The data of the obtained mechanics properties are sent to block 530.

In block 530, the anti-bucklability/anti-bucklability diagram for all concerns of low stretch and surface soft is established as illustrated in FIG. 17. The data of the stretchability/anti-bucklability diagram are sent to block 650.

In block 640, anti-bucklability indexes for each surface soft concern are calculated using the data from block 415. Anti-bucklability indexes in each deformation region and zone include the equivalent strain, and major and minor strain gradients. The calculation of equivalent strain in each deformation zone is the same as that in block 540. The major and minor strain gradients are calculated in each deformation region by using the same formulae in block 340. Finally, the data of the anti-bucklability indexes in each deformation region and zone are sent to block 650.

In block 650, the anti-bucklability status for each surface soft concern is identified. Only the equivalent strain is used for determining the anti-bucklability status. The strain gradients are taken as the properties of the anti-bucklability status in each deformation region. Comparing the anti-bucklability index from block 640 with the anti-bucklability diagram from block 530, when εₑ>εₑ^{l}, the anti-bucklability status is safe; when εₑ≦εₑ^{l}, it is unsafe as illustrated in FIG. 17. All the data of the anti-bucklability indexes with safe status are sent to block 660; and the data of the rest anti-bucklability indexes with unsafe status are sent to block 670.

In block 660, the reliability range of the stamping process regarding the surface soft concerns is established. The difference (εₑ−εₑ^{l}) is calculated as the operational anti-bucklability range for each surface soft concern. The associated strain gradients are taken as the properties of the safe anti-bucklability status. After all the operational anti-bucklability ranges in the formed workpiece are established, transforming these ranges into (a) a domain of the material properties of sheet metal establishes a part of the material window, and (b) a domain of the other six types of stamping variables establishes a part of the tooling window. Finally, putting the operational anti-bucklability ranges and partial material and tooling windows together, a part of the stamping process window is established. The partial SPW is applied for the stability control of the stamping process regarding the surface soft concerns. It is one type of the anti-bucklability solutions.

In block 670, solutions for the surface soft are developed. Amounts of metal flow adjustments for solving the surface soft are quantified by the differences between the anti-bucklability indexes and the boundaries of the anti-bucklability range. Take (εₑ^{u}−εₑ) as the maximum amount of flow adjustment, and (Δₑ^{l}−Δₑ) as the minimum amount of metal flow adjustment for each surface soft in the formed workpiece. After the ranges of metal flow adjustments for each surface soft are calculated, the data of the mechanics properties in the deformation regions/zones are used to refine and confirm the ranges of metal flow adjustments. The ranges of metal flow adjustments are further transformed into the ranges of displacements by applying the same procedure and the formulae in block 470. These ranges are then transformed into a domain of stamping variables, which are used to implement the metal flow adjustments. Putting the ranges of metal flow adjustments or displacements and the domain of stamping variables together, the solutions for the surface soft are developed. They are another type of the anti-bucklability solutions. If there is no surface soft in the formed workpiece, this function block 670 is skipped.

1. A method for performing universal formability analysis in sheet metal forming utilizing Finite Element Analysis and Circle Grid Analysis, the steps comprising:
generating Finite Element Analysis and Circle Grid Analysis strain and displacement data from a formed workpiece;
processing said strain and displacement data for defining deformation regions and constructing a strain field;
calculating formability indexes using said strain and displacement data that have been processed;
identifying formability status by comparing said formidability indexes with the formability zones in formability diagrams; and
developing results for solving metal forming defects.

2. The method of claim 1 further comprising a process of creating a database for said formability diagrams for providing data for said universal formability analysis.

3. The method of claim 2 wherein said database further comprises at least one of the steps of characterizing deformation regions, selecting stamping defect criteria, determining associated safety factors, and establishing said formability diagrams.

4. The method of claim 1 wherein said developing results further comprises a process of establishing reliability ranges of a stamping process.

5. The method of claim 4 wherein said process of establishing reliability ranges of a stamping process further comprises processes of establishing a formability window, transforming said formability window into a material window and a tooling window, and constructing a window for said stamping process.

6. The method of claim 1 wherein said developing results further comprises a process of solving stamping defects.

7. The method of claim 6 wherein said process of solving stamping defects further comprises processes of calculating amount of metal flow adjustments, transforming said amount of metal flow adjustments into a domain of the associated stamping variables for problems solving.

8. A method for performing anti-fracturability analysis in sheet metal forming utilizing Finite Element Analysis and Circle Grid Analysis, the steps comprising:
generating Finite Element Analysis and Circle Grid Analysis strain data from a formed workpiece;
processing said strain data for defining deformation zones in said workpiece;
calculating anti-fracturability indexes using said strain data which have been processed;
identifying anti-fracturability status by comparing said anti-fracturability indexes with the formability zones in anti-fracturability diagrams; and
developing results for solving metal split defects.

9. The method of claim 8 further comprising a process of creating a database for said anti-fracturability diagrams for providing data for said anti-fracturability analysis.

10. The method of claim 9 wherein said creating a database for said anti-fracturability diagrams further comprises steps of characterizing deformation zones, selecting at least one criterion of split in stamping, determining associated safety factors in each deformation zone, confirming the lower boundary of anti-fracturability range, and establishing said anti-fracturability diagrams.

11. The method of claim 10 wherein said characterizing deformation zones further comprise at least one characteristics of forming mode area, bending process model, deformation history, metal flow pattern, and ratio of a inner stamping radius to the sheet metal thickness of said workpiece.

12. The method of claim 8 wherein said developing results further comprises a process of establishing reliability ranges for concerns of splits in stamping.

13. The method of claim 12 wherein said process of establishing reliability ranges further comprises processes of establishing operational anti-fracturability ranges in said deformation zones and transforming said operational anti-fracturability zones into material and tooling windows.

14. The method of claim 8 wherein said developing results further comprises processes of calculating amount of metal flow adjustments, transforming said metal flow adjustments into a domain of stamping variables for stamping defect problem solving.

15. The method of claim 8 wherein said anti-fracturability indexes are calculated by:
RCMD=DC−εₑ
where RCMD is said anti-fracturability indexes, DC is the deformation capacity of the sheet metal on the FLC, and εₑ is the equivalent strain of said formed workpiece.

16. A method for performing anti-wrinklability analysis in sheet metal forming utilizing Finite Element Analysis and Circle Grid Analysis, the steps comprising:
generating Finite Element Analysis and Circle Grid Analysis strain and displacement data from a formed workpiece;
processing said strain and displacement data for defining deformation regions and constructing a strain field;
calculating anti-wrinklability indexes using said strain and displacement data that have been processed;
identifying anti-wrinklability status by comparing said anti-wrinklability indexes with the formability zones in anti-wrinklability diagrams; and
developing results for solving metal wrinkle defects.

17. The method of claim 16 further comprising a process of creating a database of said anti-wrinklability diagrams for providing data for said anti-wrinklability analysis.

18. The method of claim 17 wherein said creating a database for anti-wrinklability diagrams further comprises steps of characterizing deformation regions, selecting at least one wrinkle criterion, determining associated safety factors, confirming the lower boundaries of anti-wrinklability ranges, and establishing said anti-wrinklability diagrams.

19. The method of claim 18 wherein said characterizing deformation regions further comprises at least one characteristics of forming mode area, deformation history, and metal flow pattern.

20. The method of claim 16 wherein said developing results further comprises a process of establishing reliability ranges for concerns of wrinkles in said formed workpiece.

21. The method of claim 20 wherein said process of establishing reliability ranges further comprises processes of establishing an operational anti-wrinklability range for each wrinkle concern and transforming said operational anti-wrinklability range into material and tooling windows.

22. The method of claim 16 wherein said developing results further comprises processes of calculating amount of metal flow adjustments, transforming said amount metal flow adjustments into a domain of stamping variables for problem solving.

23. The method of claim 16 wherein said anti-wrinklability indexes comprise wrinkle heights and strain gradients.

24. The method of claim 23 wherein said strain gradients are calculated by:
$$\{ \begin{matrix}{grad}^{( i )} ( {ɛ}_{qcl1} ) = \frac{{ɛ}_{1}^{( i )} - {ɛ}_{1}^{( i + 1 )}}{Δ {l}^{( i )}} \\ {grad}^{( i )} ( {ɛ}_{qcl2} ) = \frac{{ɛ}_{2}^{( i )} - {ɛ}_{2}^{( i + 1 )}}{Δ {l}^{( i )}} \\ {grad}^{( i )} ( {θ}_{qcl} ) = \frac{{θ}^{( i )} - {θ}^{( i + 1 )}}{Δ {l}^{( i )}}\end{matrix}$$
where grad(ε_{qcl1}) is the major strain gradient along a quasi-contour line, grad(ε_{qcl2}) is the minor strain gradient along said quasi-contour line, grad(θ_{qcl}) is the major strain orientation gradient along said quasi-contour line, ε₁⁽ⁱ⁾ is the major strain at a point on said quasi-contour line on the sheet metal surface of said workpiece; ε₂⁽ⁱ⁾ is the minor strain at a point on said quasi-contour line on the sheet metal surface of said workpiece; θ⁽ⁱ⁾ is the angle between the major strain and the tangent line of said quasi-contour line, and Δl⁽ⁱ⁾ is the linear increment between two points on said quasi-contour line.
